(19) United States
(12) Patent Application Publication
(10) Pub. No.: US 2001/0026309 A1
(43) Pub. Date: Oct. 4, 2001

(54) Ablation image forming method

(75) Inventor: Toshihisa Takeyama, Tokyo (JP)

Correspondence Address: FRISHAUF, HOLTZ, GOODMAN,, LANGER & CHICK, P.C., 25th Floor, 767 Third Avenue, New York, NY, 10017-2023, US

(73) Assignee: KONICA CORPORATION, Tokyo (JP)

(21) Appl. No.: 09/859,170

(22) Filed: May 16, 2001

Related U.S. Application Data
(63) Continuation of application No. 09/156,936, filed on Sep. 18, 1998, now abandoned.

(30) Foreign Application Priority Data
Sep. 26, 1997 (JP) 261921/1997

(51) Int. Cl. B41J 2/435

(52) U.S. Cl. 347/224

(57) ABSTRACT

An ablstion image forming method is disclosed. The method comprises the steps of

imagewise irradiating a image forming element comprising an ablation image forming layer having a thickness of D by a laser light beam having a condensed area S at half maximum intensity so as to imagewise ablate the layer,

wherein the thickness of the image forming layer D and the condensed area S of the laser light beam satisfy the following relation;

12≦S/D≦145.

### FIELD OF THE INVENTION

This invention relates to an ablation image forming method giving an image with a high resolution and a high edge sharpness of image.

### BACKGROUND OF THE INVENTION

A recording method has been known, in which energy of light such as laser light is condensed and irradiated to a recording element to deform by fusing or remove by scattering, burning or evaporating a part of the element. Such the method has advantages that the method can be performed by dry processing using no processing solution containing chemicals and a high contrast image can be obtained since only the irradiated part of the element is deformed by fusing or removed by scattering, burning or evaporating. Accordingly, the method is applied to an optical recording element such as photoresist element and a photodisk, and a transparent original for preparation of printing plate.

For example, Japanese Patent Publication Open to Public Inspection (hereinafter referred to JP O.P.I.) Nos. 4-506709 and 6-43635 describe a recording element having an image recording layer containing a light-heat converting substance which absorbs light and converts to heat, and a heat decomposable binder resin as essential components. JP O.P.I. Nos. 64-56591, 1-99887 and 6-40163 describe an element for recording information by removing a colored binder layer by light-heat conversion. Furthermore, U.S. Pat. No. 4,254,003 describes an image forming element having a image forming layer which contains graphite or carbon black.

In the above-mentioned recording element, a sufficient resolution cannot be obtained and a smudge is formed sometimes in the imagewise exposed portion. To improve such the problem, image recording elements using a ferromagnetic powder as a colorant is proposed in JP O.P.I. Nos. 8-310124, 8-334894, 8-337053, 8-337054, 8-337055 and 9-15849. An image with high resolution and a little smudge by the use of these elements.

In such the image forming elements, however, a linearity of edge of the formed image is insufficient and the edge line is made irregular when the element is used for preparing a transparent original image for making a printing plate.

### SUMMARY OF THE INVENTION

The object of the invention is to provide an ablation image recording method by which an image with a high resolution and a high edge sharpness can be formed.

The object of the invention is attained by an ablation image forming method comprising the step of

imagewise irradiating a image forming element comprising an ablating having a thickness of D by a laser light beam having a condensed area S at half maximum intensity so as to imagewise ablate the layer,

wherein the thickness of the image forming layer D and the condensed area S of the laser light beam satisfy the following relation;

12≦D/S≦145.

### BRIEF DESCRIPTION OF THE DRAWINGS

FIG. 1 shows a schema of variation of the spot diameter of condensed laser light beam.

FIG. 2 shows a schema of variation of the spot diameter of condensed laser light beam when the exposure is given from the side of support.

FIG. 3 shows the relation between the spot diameter of condensed laser light beam and the layer relating to the image formation.

FIG. 4 shows the energy distribution in a pulse of laser light.

FIG. 5 shows the area of the imagewise exposed portion when the scanning exposure is performed by means of a laser light, one pulse of which has a Gaussian energy distribution.

FIG. 6 shows another example of energy distribution of one pulse of laser light.

FIG. 7 shows the area of the imagewise exposed portion when the scanning exposure is performed by means of a laser light beam, one pulse of which has a rectangular energy distribution with respect to the scanning direction.

FIG. 8 shows an image forming method according to the invention.

FIG. 9 shows the cross-section of a peeling sheet.

FIG. 10 shows another method for forming an image.

FIG. 11 shows the procedure for determining the largest fluctuation of width of the edge of image AM in Example 1.

FIG. 12 shows the procedure for determining the average width of an image N and the difference between the largest width and the smallest width AN in example 1.

FIG. 13 shows the procedure for determining the largest fluctuation of width of the edge of image ΔM in Example 2.

The symbols in the figures are as follows:

1, 1′ Support

2 Layer containing the substance absorbing laser light

3 Protective layer

4 Image forming element

5 Adhesive layer

6 Peeling sheet

### DETAILED DESCRIPTION OF THE INVENTION

<Image Forming Element>

In the invention, the ablation image forming layer, hereinafter referred to the ablating layer, is a layer relating to the image formation, and includes a layer all or a part of which is made separable from the unexposed part by melting and deforming when the layer is irradiated by a laser beam, and a layer which is separated from the unexposed part by scattering, burning or evaporating by irradiation by a laser light beam. The ablating layer may comprise single or plural layers. In other ward, a layer, which is not separated from the unexposed part after exposure to the laser beam, is not the ablating layer in the invention. At least one of the layers included in the ablating layer contains a substance capable absorbing light of laser, hereinafter referred to a laser light absorbing substance.

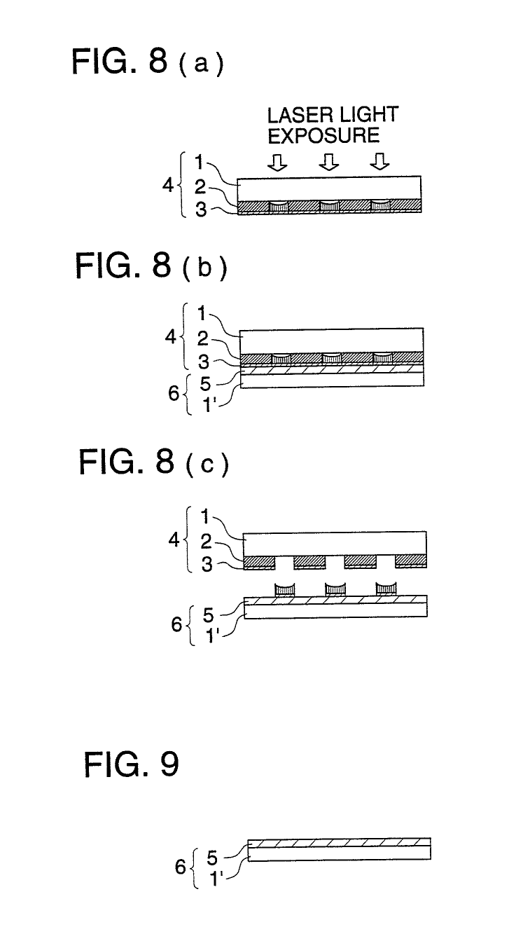

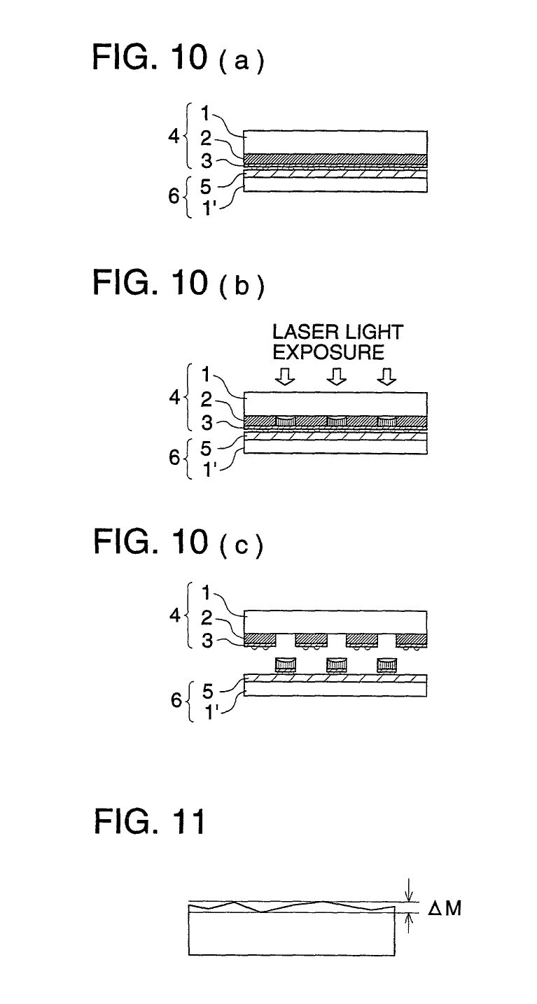

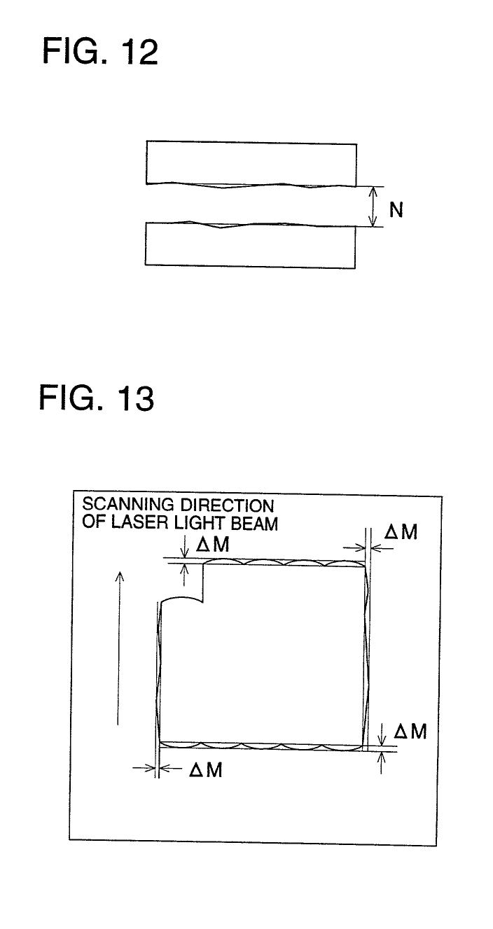

Examples of the ablating layer are shown in FIG. 8 and 10, in this case, the ablating layer contains a layer 2 containing a laser light absorbing substance, and a protective layer 3.

In the invention, the thickness of the ablating layer, the thickness of layer containing a laser light absorbing substance, or the average diameter or the average length of the major axis of the particles contained in such the ablating layer is conformed to the condensed area of the laser beam at half maximum intensity. The condensed area of laser light beam at half maximum density is described in FIGS. 4 and 6.

A typical image forming element according to the invention comprises a support and a ablating layer provided on one side of the support.

It is preferred to ablate the layer containing the laser light absorbing substance since the remaining density at the ablated portion is preferably little when the formed image is directly used as the transparent original image for making a printing plate. When the image released from the element by ablation is utilized, such as in preparation of a color proof, it is preferred to make ablate so as to remain the layer containing the laser light absorbing substance on the element side since the color contamination is hardly made.

An element suitable for the former case is described in detail below, in which the image formed on the element is directly used as the transparent original for preparation of a printing plate.

In such the case, a plastic film made from a polyacrylate, a polymethacrylate, polyethylene terephthalate, polybutylene terephthalate, polyethylene naphthalate, polycarbonate, polyallylate, polyvinyl chloride, polyethylene, polypropylene, polystyrene, nylon, an aromatic polyamide, polyether-ether-ketone, polysulfone, polysulfine, polyethersulfone, polyimide, or polyetherimde, and a film composed of two or more laminated layers of the above-mentioned resins are usable for the support of the image forming element.

In the invention, a support stretched in a form of film and heat set is preferred from the viewpoint of dimension stability. In the invention, it is preferred that the support has a high transparency at the effective wavelength region of the laser light to be irradiated since the image forming element is imagewise exposed to condensed laser light come from the support side through the support when the image formation is performed according to the later-mentioned image forming method. The transparency of the support is usually not less than 50%, preferably not less than 80%. A filler such as titanium oxide, zinc oxide, barium sulfate, and calcium carbonate, may be added into the support unless the effect of the invention is not disturbed. The thickness of the support is usually from 10 to 500 μm, preferably from 20 to 250 μm.

In the image forming element of the invention, it is preferred to contain a substance absorbing light within the range of wavelength of the laser light in the layer to effectively absorb the condensed laser light and to make ablation. The wavelength of the laser light is preferably 600 to 1200 nm, which is electromagnetic wave capable of being condensed in a small energy applying area, for conversing the energy of light to heat energy and effectively making ablation.

As the substance having an absorption within the wavelength region of the laser light, the following substances are usable; an organic compound such as a cyanine dye, a rhodacyanine dye, an oxonol dye, a carbocyanine dye, a dicarbocyanine dye, tricarbocyanine dye, a tetracarbocyanine dye, a pentacarbocyanine dye, a styryl dye, a pyrylium dye, a phthalocyanine dye, a metal-containing dye, and an inorganic compound such as graphite, carbon black, a metal nitride, a metal carbide, a metal boride, tricobalt tetraoxide, iron oxide, chromium oxide, copper oxide, titanium black and a magnetic powder. Among them, one having both of the functions of a colorant and a light-heat conversing substance is preferably used since such the substance gives a high efficiency.

Among the foregoing substance having an absorption within the wavelength region of the laser light, a particle having the absorption not only within the wavelength region of from 600 to 1200 nm but within the region of from 400 to 600 nm such as the graphite, carbon black, metal carbide, metal boride and magnetic powder, is preferably used for forming a black image suitable for a transparent original image for preparation of printing plate or an image for medical diagnosis. The magnetic powder is particularly preferred from the point of resolution of the image and the remaining density in the ablated area. As the magnetic powder, a ferromagnetic iron oxide powder, a ferromagnetic metal powder, and a tabular powder of crystals of cubic crystal system are usable. Among them, the ferromagnetic metal powder is suitably usable.

As the ferromagnetic metal powder, a ferromagnetic metal powder such as Fe, Co, Fe—Al, Fe—Al—Ni, Fe—Al—Zn, Fe—Al—Co, Fe—Al—Ca, Fe—Ni, Fe—Ni—Al, Fe—Ni—Co, Fe—Ni—Zn, Fe—Ni—Mn, Fe—Ni—Si, Fe—Ni—Si—Al—Mn, Fe—Ni—Si—Al—Zn, Fe—Ni—Si—Al—Co, Fe—Al—Si, Fe—Al—Zn, Fe—Co—Ni—P, Fe—Co—Al—Ca, Ni—Co, and a metal magnetic powder containing Fe, Ni or Co as the principal component thereof are usable. Among them, a Fe type metal powder is preferred.

The shape of the ferromagnetic metal powder is preferably from 0.05 to 1.00 μm, preferably from 0.08 to 0.80 μm in the length of major axis, even though the shape may be changed according to the spot diameter or the area of the condensed laser light. The sharpness of the image edge can be improved by the use of such the ferromagnetic metal powder.

In the invention, the laser light can be absorbed with a higher efficiency by the used of two or more kinds of particle different from each other in the size or by the use of a dye having a strong absorption at the effective wavelength region of the laser light together with the particle.

The content of the substance absorbing the laser light in the layer containing such the substance is usually from 50 to 99%, preferably from 60 to 95%, by weight.

The layer containing the substance absorbing the laser light contains a binder resin to sustain the substance. As such the binder, polyurethane resin, a polyester resin, a vinyl chloride resin, a polyvinyl acetal resin, a cellulose resin, an acryl resin, a phenoxy resin, a polycarbonate resin, a polyamide resin a phenol resin and an epoxy resin can be cited. It is preferred for raising the dispersibility of the particles in the resin that the binder contains a polar group selected from —SO₃M, —OSO₃M, —COOM and —PO(OM₁)₂, in which M is a hydrogen atom, or an alkali metal atom and M₁ is a hydrogen atom, an alkali metal atom or an alkyl group. The content of the binder resin is usually from 1 to 50%, preferably from 5 to 60%, by weight of the whole components of the layer containing the substance absorbing the laser light.

Moreover, an additive such as a hardener to harden the binder resin, a filler, a lubricant, a dispersant and an antistatic agent may be added to the layer relating to image formation in addition to the substance absorbing the laser light and the binder unless the effect of the invention is not disturbed.

As the hardener, a isocyanate and a carbodiimide hardener can be cited. As the filler, an inorganic compound such as SiO₂, TiO₂, BaSO₄, ZnS, MgCO₃, CaCO₃, ZnO, CuO, CaO, WS₂, MoS₂, MgO, SnO₂, Al₂O₃, α—Fe₂O₃, α—FeO₂H, SiC, CeO₂, MoC, BC, WC, BN, SiN, titanium carbide, corundum, artificial diamond, garnet, silica rock, diatomaceous earth, dolomite and an organic compound such as a polyethylene resin particle, fluororesin particle, guanamine resin particle, acryl resin particle, silicone resin particle and melamine resin particle can be cited. For improving the sharpness of the edge of image, the average diameter of these fillers is from 0.005 to 1.00 μm, preferably from 0.01 to 0.80 μm, even though the diameter may be changed according to the spot diameter or area of the condensed laser light beam as well as in the case of the substance absorbing the laser light.

As the lubricant, a fatty acid, fatty acid ester, fatty acid amide, (modified) silicone oil, (modified) silicone resin, fluororesin, carbon fluoride, and wax may be used. As the dispersant, a fatty acid having from 12 to 18 carbon atoms such as lauric acid and stearic acid, and an amide, alkali metal salt and alkali-earth metal salt thereof, a polyalkylene oxide alkylphosphate salt, lecithin, trialkyl polyolefin oxy -quaternary ammonium salt, azo compound having a carboxyl group and a sulfonic group are usable. As the antistatic agent, a cationic surfactant, an anionic surfactant, a nonionic surfactant, a high molecular antistatic agent and a electric conductive fine particle are usable.

The amount of these additives is usually from 0 to 20%, preferably from 0 to 15%, by weight of the whole components of the layer containing the substance absorbing the laser light.

The thickness of the layer containing the substance absorbing the laser light is usually from 0.05 to 5.0 μm, preferably from 0.1 to 3.0 μm, even though the thickness may be changed depending on the spot diameter or the area of condensed laser light beam. The layer may be composed of single layer or plural layers different each other in the composition thereof.

In the invention, it is preferred to provide a protective layer on the layer containing the laser light absorbing substance to raise the durability of the formed image. Such the protective layer can be composed of a binder and various additives which are added according to necessity.

As the binder resin of the protective layer, a polyurethane resin, polyester resin, vinyl chloride resin, polyolefin resin, polyvinyl acetal resin, cellulose resin, styrene resin, acryl resin, polyamide resin, phenol resin, polyvinyl alcohol, and gelatin may be optionally selected. The resin may be used singly or in combination of two or more. The content of the binder in the protective layer is usually from 10 to 100%, preferably from 40 to 100%, by weight of the components forming the protective layer. When a binder resin having a reactive hydrogen atom in the molecular thereof may be used for raising the durability of the protective layer, an isocyanate compound or a carbodiimide compound is preferably added as well as in the case of the layer containing the laser light absorbing substance. When a binder resin having an epoxy group is used, a thermal hardening agent such as an amine compound is preferably added.

An additive such as a filler, a lubricant, a dispersant, and an antistatic agent may be added to the protective layer unless the effect of the invention is not disturbed. The additive may be optionally selected from the components of the layer containing the laser light absorbing substance. The amount of the additive is usually from 0 to 90%, preferably from 0 to 60%, by weight of the components forming the protective layer.

The thickness of the protective layer is usually from 0.03 to 2.0 μm, preferably from 0.05 to 1.0 μm, even though the thickness may be changed depending on the spot diameter or the condensed are of laser light. The protective layer may be composed by single layer or plural layers different from each other in the composition thereof.

A backing layer having a thickness of from 0.001 μm to 10 μm may be provided on the back side of the support of the image forming element for the purpose of antistatic, improvement of the transportability, and prevention of double feeding.

In the later-mentioned image forming method, a resin sheet having a thermally sealing property or a sheet composed of a adhesive layer provided on a support such as one usable as the support of the image forming element may be used as the peeling sheet to take out the image after the imagewise irradiation by laser light. The adhesive layer may be both of one adhesive itself at an ordinary temperature, and one which is made adhesive by applying heat or pressure. For example, the adhesive layer may be composed of a resin having a low softening point, a adhesiveness providing agent, a thermal solvent and a filler.

As the resin having a low softening point, a polystyrene resin, a polyester resin, a polyolefin resin, a polyvinyl ether resin, an acryl resin, an ionomer resin, a cellulose resin, an epoxy resin, a vinyl chloride resin, and a urethane resin are useful. As the adhesiveness providing agent, a unmodified or modified rosin such as rosin, hydrogenated rosin, rosin maleic acid, polymerized rosin and rosin phenol, terpenes, petroleum resin and its modified product are usable. As the thermal solvent, a compound which is solid at an ordinary temperature and reversibly liquefied or softened at a heated condition, may be optionally used. As the filler, those usable in the layer containing the laser light absorbing substance are optionally used.

The thickness of the peeling sheet is usually from 6 μm to 100 μm, preferably from 10 μm to 30 μm, and that of the adhesive layer is usually from 0.05 μm to 30 μm, preferably from 0.1 to 20 μm.

When the layer containing the laser light absorbing substance is coated on the support, the layer may be directly coated on the support. The surface of the support may be modified by applying a known surface modifying technique such as corona discharge treatment or an anchor coat treatment of the support surface to improve the coating ability of the coating liquid and the adhesiveness with the coated layer.

The above-mentioned layer containing the laser light absorbing substance and the protective layer can be formed on the support by the use of a known coating method. The coating liquids of the layer containing the laser light absorbing substance and the protective layer each can be prepared by dissolving or kneading and dispersing the components of each of these layers in a solvent, respectively.

As the solvent, one having a solubility parameter of from 6.0 to 15, which is described in “Solvent Pocket Book” published by Yuuki Gousei Kagaky Kyoukai (the Society of Organic Synthesis Chemistry), may be used. Water, an alcohol such as ethanol and propanol, a cellosolve such as methyl cellosolve and ethyl cellosolve, an aromatic compound such as toluene and xylene, a ketone such as methyl ethyl ketone and cyclohexanone, an ester such as ethyl acetate and butyl acetate, a halogen-containing solvent such as chloroform and dichlorobenzene, a nitrogen-containing solvent such as dimethylformamide and N-methylpyrrolidone and a sulfur-containing solvent such as dimethyl sulfoxide are usable.

When a particle is used as the laser light absorbing substance, a two-roller mill, a three-roller mill, a ball mill, a pebble mill, a coball mill, a tron mill, a sand mill, a sand grinding mill, a sqegvari attriter, a high-speed impeller disperser, a high-speed stone mill, a high-speed impact mill, a disper, a high-speed mixer, a homogenizer, an ultrasonic dispersing machine, an open kneader, and a continuous kneader are usable to kneed and disperse the particle.

To coat the coating liquids prepared according to the above-mentioned, in each of which the components for forming the layer containing the laser light absorbing substance and the components for forming the protective layer are dissolved and/or dispersed, various kinds of known coater such as an extrusion coater, a reverse roller coater, a gravure roller coater, an air doctor coater, a blade coater, an air knife coater, a squeeze coater, an immersion coater, a bar coater, a transfer roller coater, a kiss coater, a cast coater, and a spray coater may be used. Among them, in the case of the coating of the layer containing the laser light absorbing substance, the extrusion coater and the roller coater such as the rivers roller coater are preferable to inhibit the unevenness of the coated layer. For coating of the protective layer, any coater may be used with no limitation unless the coater does not give any damage to the layer containing the laser light absorbing substance. However, a coater suitable for coating a thin layer is preferable among the above-mentioned coaters since the protective layer is thin. Accordingly, the extrusion coater, the gravure roller coater and the bar coater are useful. When the coating method using the gravure roller coater or the bar coater is applied, in which the coating roller is touched to the layer containing the laser light absorbing substance, the rotating direction of the gravure roller or the bar may be the same as or reverse to the transporting direction of the support to be coated. In the case of the rotating direction is the same as the transporting direction, the circumferential speed of the roller may be the same or different from the transporting speed. When the coating method accompanied with touching to the surface, it is preferred that the layer containing the laser light absorbing substance is subjected to a surface smoothing treatment such as a calender treatment after coating thereof, or the layer containing the laser light absorbing substance is thermally hardened by aging after coating thereof. Furthermore, it is preferred to add a filler different from the laser light absorbing substance to the composition for forming the layer containing the laser light absorbing substance, since the scraping of the layer can be inhibited.

In the calender treatment, the support on which the layer containing the laser light absorbing substance has been coated is passed between a metal nip roller having a high surface smoothness and a diameter of from 1 cm to 100 cm, and a heating roller facing to the nip roller while applying heat and pressure. A vacant space in the layer containing the laser light absorbing substance formed in the process of coating and dying the layer is reduced and the filling ratio is raised by the calender treatment. The calender treatment is performed while applying a line nip pressure of from 2 to 500 kg/cm, preferably from 5 kg/cm to 300 kg/cm, at a temperature of from 40° C. to 200° C., preferably from 50° C. to 120° C., for raising the filling ratio. The optimum heating temperature is changed depending on the transporting speed. Accordingly, the temperature is usually set so that the maximum instantaneous temperature of the layer is a temperature of from about 30° C. to 100° C. The transporting speed is usually from 10 m/min. to 800 m/min., preferably from 30 m/min. to 200 m/min.

When the layer containing the laser light absorbing substance is subjected to aging, in the case of using a thermal hardener, the temperature is usually from 30 to 65° C., preferably from 45 to 60° C., and the heating period is usually from 24 to 240 hours, preferably from 48 to 168 hours, even though the conditions may be changed depending on the kind of hardener and the thermal shrinkage of the support.

When plural kinds of layers each containing the laser light absorbing substance are provided, each of the layers may be separately coated and dried or the layers may be simultaneously coated and dried by wet-on-wet procedure. In the case of wet-on-wet coating, the coating can be performed by a combination of the extrusion coater and a coater selected from the rivers coater, gravure roller coater, air doctor coater, blade coater, air knife coater, squeeze coater, immersing coater, bar coater, transfer roller coater, kiss coater, cast coater and spray coater. In the case of the simultaneous coating by wet-on-wet coating procedure, the adhesiveness between upper and lower layer is raised since the upper layer is coated on the lower layer in a wet state.

When a peeling sheet is provided on the layer containing the laser light absorbing substance or the protective layer, such the element can be prepared by sticking a peeling sheet to the layer containing the laser light absorbing substance or the protective layer. In the procedure for sticking the peeling sheet to the layer containing the laser light absorbing substance or the protective layer, when a resin film is used in the peeling sheet, the sheet can be stuck by putting the sheet on the layer containing the laser light absorbing substance or the protective layer and applying heating and pressuring by a heating roller or a hot stamp, if the sheet is a film having a heat sealing ability such as polyethylene and polypropylene. When a peeling sheet composed of a resin film such as the film to be used as the support of the element and an adhesive layer provided thereon is used, the sheet can be stuck by putting the sheet on the layer containing the laser light absorbing substance or the protective layer so as to face the adhesive layer to the layer containing the laser light absorbing substance or the protective layer and applying heat and pressure by a heating roller or a hot stamp. When the heating roller is used, the heating temperature is usually from a room temperature to 180° C., preferably from 30° to 160° C. and the line pressure is usually from 1.0 kg/cm to 20 kg/cm. preferably from 0.5 kg/cm to 10 kg/cm, and the transporting speed is usually 1 to 1000 mm/second, preferably from 5 mm/second to 500 mm/second. When the hot stamp is used, the heating temperature is usually from a room temperature to 180° C., preferably from 30° to 150° C., the pressure is usually 0.05 kg/cm² to 10 kg/cm², preferably from 0.5 kg/cm² to 5 kg/cm², and the time for heating and pressing is usually 0.1 seconds to 50 seconds, preferably 0.5 seconds to 20 seconds.

<Image Forming Method>

In the invention, the sharpness of the edge of image can be improved by controlling the area of the condensed laser light beam so as to satisfy the relation of 12≦S/D≦145, preferably 12≦S/D≦125, in which S is the area of the condensed laser light beam at half maximum intensity I and D is the thickness of the ablating layer of the image forming element. It is preferred to satisfy the condition of 15≦S/d≦170 or 30≦S/R≦1250, in which d is the thickness of the layer containing the laser light absorbing substance and R is the average diameter or the average length of the major axis of the particle contained in the layer containing the laser light absorbing substance. Further, when the condensed laser light beam has a shape of circular spot such as in FIGS. 4(a) and 4(b), it is preferred that the diameter of the condensed laser light beam spot L at half maximum intensity I has a relation to the above D, d and R of 4≦L/D≦15, 5≦L/d≦17 and 10≦L/R≦125, respectively.

By setting the conditions so as to satisfy the above-mentioned, the line width of the recorded image can be made within the range of from 0.9 to 1.1 times of that of the original image. In the case of a half-tone image, recorded image can be made within the range of ±2% of the original image. Moreover, the fluctuation of the density in a same pattern image, the remaining density of a uniformly exposed area and the density fluctuation in the uniformly exposed area can be reduced each to not more than 0.1, not more than 0.1 and not more than 0.05, respectively.

The image forming method of the invention is described below according to drawings.

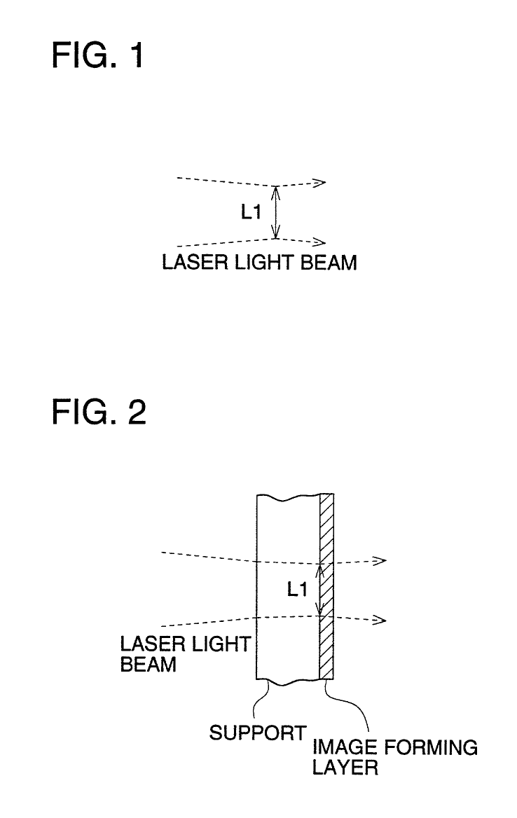

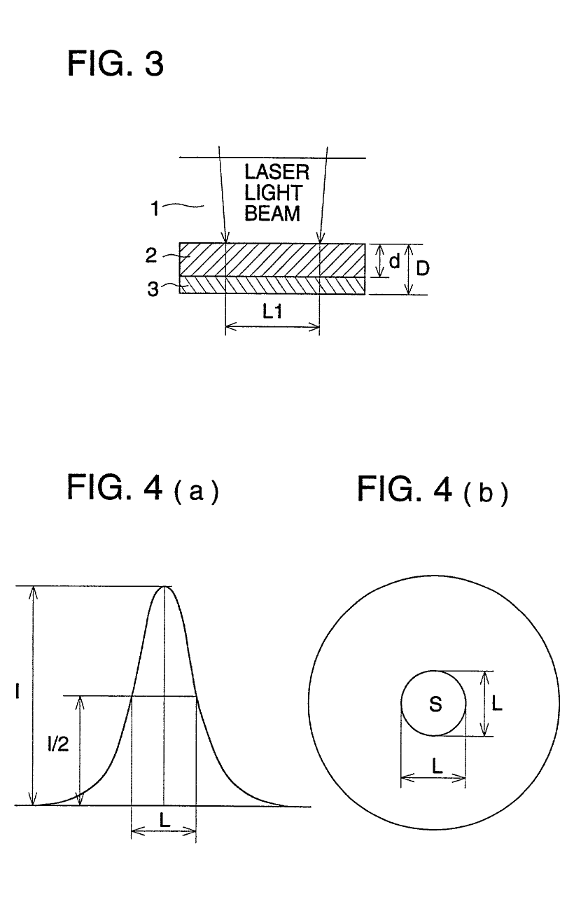

FIG. 1 is a schematic-drawing showing the variation of the spot diameter L1 of laser light condensed for giving an imagewise exposure. FIG. 2 is a schematic drawing showing the variation of the spot diameter L1 of laser light when the light is irradiated from the support side. FIG. 3 shows the relation of the spot diameter L1 and the layer relating to image formation in the case of FIG. 2.

In the invention, as shown in FIG. 3, it is preferred that the laser light is condensed at the interface of the layer containing the laser light absorbing substance 2 and the transparent support 1 so that the spot diameter L of the laser light is made smallest and the condensed energy is made highest to perform the imagewise exposure. As above-mentioned, the distribution of energy is made sharp by controlling the focus so as to make small the spot diameter. As a result of that, the sharpness of the edge of image can be raised compared with the case in which the focus is moved to the side of the transparent support 1 or the side of the layer containing the laser light absorbing substance 2. In the invention, a laser generating a pulse having a Gaussian energy distribution as shown in FIG. 4 or one generating a pulse having a rectangular distribution as shown in FIG. 6 may also be used.

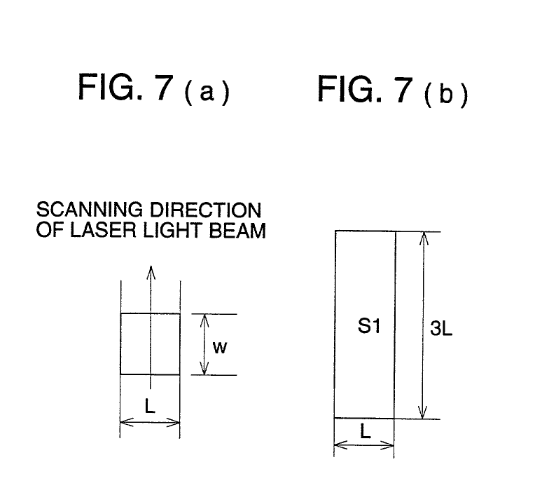

The spot diameter of the laser light L at half maximum intensity I is that shown in FIG. 4(a) when the energy distribution of one pulse is Gaussian distribution, and the area of spot S is that shown in FIG. 4(b). When the energy distribution is rectangular with respect to the scanning direction, L is that shown in FIG. 6(a) and S is that shown in FIG. 6(b). In FIGS. 6(a), 6(b) and 7(a), w is width of the laser light beam.

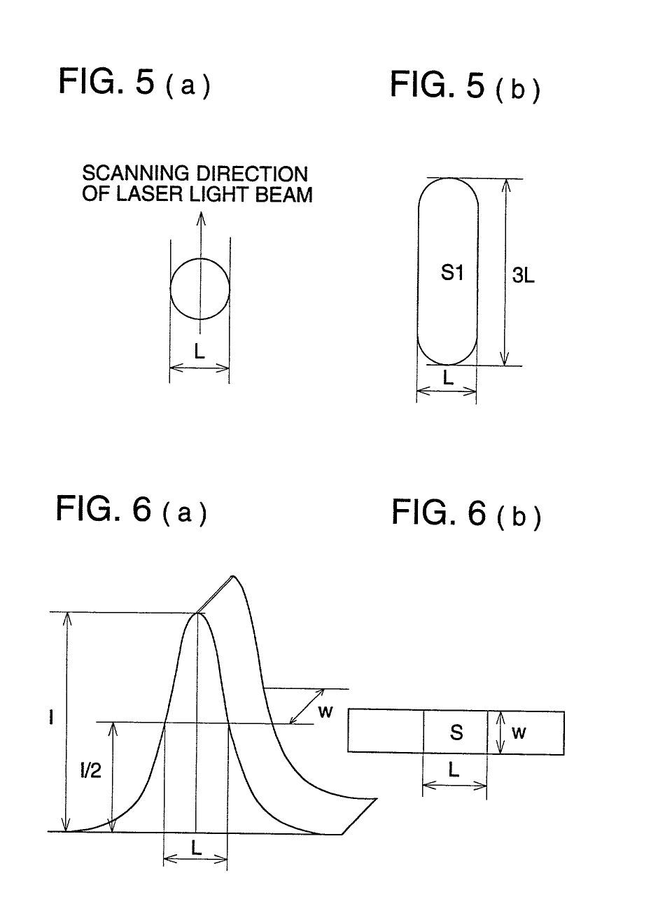

The area S1 imagewise exposed by scanning by the laser light beam is that shown in FIG. 5(b) in the case of the laser generating the light pulse having the Gaussian energy distribution shown in FIG. 5(a). In the case of the laser generation the light pulse having the rectangular energy distribution shown in FIG. 7(a) with respect of the scanning direction, S1 is that shown in FIG. 7(b).

The sharpness of the edge of image is raised and the area of the recorded dot image is near the condensed area S by satisfying the relation of 12≦S/D≦145, preferably 12≦S/D≦125.

It is preferable to make the S/d value within the range of 15≦S/d≦170. By such the adjustment, the sharpness of the edge of image can be raised and the area of dot image can be near the condensed spot area S. Furthermore, the density in the ablated area in the recorded image can be made uniform.

The sharpness of the edge of image is raised and the area of the recorded dot image is near the condensed area S by satisfying 30≦S/R≦1250. Furthermore, the density in the ablated area in the recorded dot image is lowered.

To form an image by the foregoing image forming element, an image forming element 4 composed of a support 1 on which a layer 2 containing the laser light absorbing substance and a protective layer 3 provided in this order, is used. Imagewise exposure is given by laser light from the support side so as to ablate the layer 2 containing the laser light absorbing substance (FIG. 8(a)). Then the surface of the protective layer of the image forming element 4 is faced to a peeling sheet 6 composed of a support 1′ having thereon a adhesive layer 5, and stuck by a heating and pressing treatment (FIG. 8(b)). Thereafter, the peeling sheet 6 is peeled from the image forming element 4. Thus the exposed area is transferred to the peeling sheet and an image can be formed (FIG. 8(c)).

The “ablation” includes the following phenomena; the layer 2 containing the laser light absorbing substance and the protective layer 3 are completely scattered, a part of the layer 2 containing the laser light absorbing substance and that of the protective layer 3 are destroyed and/or scattered, the layer 2 containing the laser light absorbing substance is only destroyed, and a physical or chemical change is only formed at the position near the interface between the layer 2 containing the laser light absorbing substance and the support In the course of imagewise exposure by laser light, a scanning exposure is possible by means of a light condensed in a form of beam. Furthermore, an image with high resolution can be formed when a laser is used as the light source since the area of exposure can be easily made very fine. As the laser light source, a well known solid laser such as a ruby laser, a YAG laser, and a glass laser; a gas laser such as a He—Ne laser, an Ar ion laser, a Kr ion laser, a CO₂ laser, a CO laser, a He-a Cd laser, a N₂ laser and an excimer laser; a semiconductor laser such as an InGaP laser, an AlGaAs laser, a CdSnP₂ laser and a GaSb laser; a chemical laser and a dye laser are usable. Among them, the use of a laser generating light having a wavelength of from 600 nm to 1200 nm is preferable for making ablation with a high efficiency. Such the wavelength of light is preferred from the view point of the sensitivity since energy of the light can be converted to energy of heat. It is preferred to give imagewise exposure so that the ablation is occurred only at the interface between the support and the layer containing the laser light absorbing substance, since the imagewise exposed portion can be uniformly transferred without scattering of dust during the exposure.

As the peeling sheet, a peeling sheet available on the market, a heat sealing material or a laminated material can directly be used and the foregoing sheet having a adhesive layer can also be used.

For giving the heating and pressing treatment to the image forming element and the peeling sheet faced to each other, any method can be used without any limitation unless a good adhesion can be obtained without formation of bubbles by the heating and pressing treatment. A pressure roller and a stamper are usable for the pressing treatment, and a thermal head, a heating roller and a hot stamp are usable for the heating and pressing treatment.

When the pressure roller is used, the pressure is preferably from 0.1 kg/cm to 20 kg/cm, more preferably from 0.5 to 10 kg/cm, and the transporting speed is preferably from 0.1 mm/second to 1000 mm/second., more preferably from 0.5 mm/second to 500 mm/second. When the stamper is used, the pressure is preferably from 0.05 kg/cm² to 10 kg/cm², more preferably 0.5 kg/cm² to 5 kg/cm², and the pressing time is preferably from 0.1 seconds to 50 seconds, more preferably from 05 to 20 seconds. When the heating roller is used, the heating temperature is preferably from 60° to 200° C., more preferably from 80° to 180° C., the pressure is preferably from 0.1 to 20 kg/cm, more preferably from 0.5 kg/cm to 10 kg/cm, and the transporting speed is preferably from 0.1 mm/second to 1000 mm/second, more preferably from 0.5 mm/second to 500 mm/second. When the hot stamp is used, the heating temperature is preferably from 60° to 200° C., more preferably from 80° to 150° C., the pressure is preferably from 0.05 kg/cm² to 10 kg/cm², more preferably from 0.5 kg/cm² to 5 kg/cm², and the heating time is preferably from 0.1 seconds to 50 seconds, more preferably from 0.5 seconds to 20 seconds.

To peel the sheets, various method, such as a fixed peeling angle method using a peeling roller and a hand peeling method without fixing the peeling sheet and the image forming element, can be applied unless does not influence to the image formation.

In the invention, both of the image formed on the image forming element 4 and the image transferred on the peeling sheet 6 can be used as the recorded image according to the use. When a high density and/or a high scratch resistivity are required, it is preferred to use the unexposed portion on the support 1 as the image. Such the image is preferable for the use of a transparent original image for preparation of a printing plate, an OHP or a medical image since a scratch is difficultly formed.

Another image forming method according to the invention is described below.

An image forming element 4 shown in FIG. 10(a) on which a peeling sheet 6 is contacted is used. The image forming element 4 is imagewise exposed to laser light from the side of the support 1 to lower the combining force between the layer 2 containing the laser light absorbing substance and the support 1 at the exposed portion (FIG. 10(b)). Then the exposed portion of the layer 2 containing the laser light absorbing substance and the protective layer 3 is transferred to the peeling sheet 6 side by peeling the peeling sheet 6 (FIG. 10(c)).

In the case of the foregoing image forming method, the image forming layer is scattered sometimes depending on the exposure condition at the time of the imagewise exposure. However, by this method, the image formation can be performed without occurring such the scattering since the peeling layer is provided on the image forming layer.

In such the case, one in which the image forming element 4 and the peeling sheet are simply piled in contact, or one in which the image forming element 4 and the peeling sheet are integrated by adhesion, may be optionally selected for use. When the image forming element 4 and the peeling sheet simply contacted to each other such as the former are used, the image can be formed by the heating and heating treatment after imagewise exposure by laser light and peeling the peeling sheet 6. In the case of the later, the image can be formed by peeling the peeling sheet only since the image forming element and the peeling sheet are previously adhered. Such the method is preferable since the image forming process is simple and the heating and pressing device is not necessary, and the apparatus can be made compact.

The source of laser light, the pressing or heat-pressing method and the apparatus therefor, and the method to peel the peeling sheet 6 from the image forming element 4, to be applied for image formation by using the image forming element 4 contacted with the peeling sheet 4 may be optionally selected from those used in the foregoing image forming method.

### EXAMPLES

In the followings, “part” means “part by weight of an effective component” except that a specific description is added and “diameter” and “area” of the condensed laser light beam are each means those defined at half maximum intensity of the light beam, respectively.

### Example 1

The following composition for forming the layer containing the laser light absorbing substance was kneaded and dispersed by a Henschel mixer and a sand mixer. Then 1.61 parts of a polyisocyanate compound, Cronate HX, effective component content: 100%, manufactured by Nihon Polyurethane Industry Co. Ltd., was added to the composition and stirred by a dissolver to prepare a coating liquid for forming the layer containing the laser light absorbing substance.

The coating liquid was subjected to ultrasonic dispersion and coated and dried by an extrusion coating method on the foregoing transparent polyethylene terephthalate film, Lumirror T60 manufactured by Toray Co., Ltd., which had a thickness of 100 μm and was subjected to a corona discharge treatment on one side thereof. After drying, the coated layer was subjected to a calender treatment using a heat roller under conditions of a temperature of 100° C., a line pressure of 150 kg/cm and a transporting speed of 60 m/sec. and an aging at 60° C. for 168 hours. The coating amount of the composition was varied so that the dried thickness d of the layer was made as described in Table 1.

<Composition for forming the layer containing the laser light
absorbing substance>

| | | |
|---|---|---|
| Fe-Al ferromagnetic metal powder | 100 | parts |
| (atomic ratio of Fe:Al = 100:3, | | |
| average length of major axis: 0.16 μm) | | |
| Polyurethane resin (Vylon UR-8200 Toyobo Co., Ltd.) | 10.0 | parts |
| Polyester resin (Vylon UR-200 Toyobo Co., Ltd.) | 5.0 | parts |
| Silicon nitride | 5.0 | parts |
| (average particle diameter: 0.30 μm, GC-5A, | | |
| Fujimi Kemmazai Kogyo Co., Ltd.) | | |
| Phosphoric acid ester (Phosphanol RE610, | 3.0 | parts |
| Toho Kagaku Co., Ltd.) | | |
| Methyl ethyl ketone | 105.0 | parts |
| Toluene | 105.0 | parts |
| Cyclohexanone | 90.0 | parts |

Thereafter, a protective layer coating liquid having the following composition was prepared and subjected to a ultrasonic dispersion treatment. The coating liquid was coated by a extrusion coating method on the above-mentioned layer containing the laser light absorbing substance. After drying, the coated element was aged at 60° C. for 72 hours. The coating amount of the protective layer was varied so that the thickness of the protective layer D2 was as shown in Table 1.

<Coating Liquid for Forming Protective Layer>

<Coating liquid for forming protective layer>

| | | |
|---|---|---|
| Phenoxy resin (PKHH, Phenoxy Associate Co., Ltd.) | 7.30 | parts |
| Silica (average particle diameter: 0.3 μm, | 0.20 | parts |
| Adomafine SO-C1, surface treated by silicone | | |
| compound, Adomatex Co., Ltd.) | | |
| Polyethylene wax dispersion (Microflat CE-155, | 3.33 | parts |
| Koyo Kagaku Co., Ltd.) | | |
| Polyisocyanate compound (Coronate HX, Nihon | 2.00 | parts |
| Polyurethane Kgyo Co., Ltd.) | | |
| Toluene | 112.30 | parts |
| Cyclohexanone | 74.87 | parts |

Besides, a solution of polyurethane resin, Nipporane 3116, Nihon Polyurethane Co., Ltd., having a solid content of 5% in a mixed solvent composed of toluene/methyl ethyl ketone/cyclohexanone=4/4/1 was coated on the treated surface of a transparent PET film, T100E, Diafoil-Hoechst Co., Ltd., by a bar coater to form a adhesive layer of 0.55 μm to prepare a peeling sheet. The film had been subjected to a treatment on one side to give an adhering ability with the coated layer.

The surface of the protective layer of the above-mentioned image forming element and the adhesive surface of the peeling sheet were faced to each other and adhered by a heat-pressing treatment with roller temperature of 85° C., a transporting speed of 100 mm/second and a pressure of 6.0 kg/cm to prepare an integrated image forming element.

The above-mentioned integrated image forming element was imagewise exposed by scanning by a light beam generated from a semiconductor laser, LT090MD, Sharp Co., Ltd., generating light having a principal wavelength at 830 nm, from the side of the support or through the support. The laser light was focused at the interface between the layer containing the laser light absorbing substance and the transparent support.

The image forming element was fixed on a flat plate and the peeling sheet under the condition of a peeling angle of 180° and a peeling speed of 40 mm/second, to take out the exposed portion to the adhesive tape side to form an image. The edge sharpness and the reproducibility of the condensed area of light S of the image formed on the support were evaluated according to the following method.

<Sharpness of the Edge Portion: ΔM>

The element was exposed by scanning to a laser beam having a Gaussian energy distribution, a beam diameter of 6.35 pm, a condensed area of light of 31.67 μm², and exposing energy of 280 mJ/cm² so that a halftone image composed of square dots of 175 line, 90% and angle of 0° was formed. Thus formed image was microscopically observed, and the maximum deviation width ΔM of the image edge was measured and evaluated as shown in FIG. 13. Here, the percentage of the dot image is the value of the different of 100% and the dot percentage at the exposed portion.

<Reproducibility of the Condensed Area of Laser Light: T, ΔT>

A halftone image having an area of 100 mm×100 mm and a dot-percentage of 50% composed of round dots of 175 line and 45° was formed by a laser beam having a diameter of 6.35 μm, a condensed area of 31.67 μm² and a scanning pitch of 6.35 μm, or a diameter of 5.0 μm, a condensed area of 19.63 m a scanning pitch of 5.0 μm and exposing energy of 280 mJ/cm². The transmission density of the halftone image was measured at optionally selected 100 points by a densitometer X-rite 310TR, manufactured by X-rite Co., Ltd., at the visual density mode. The average dot percentage T and the difference between the maximum value and the minimum value of the dot percentage ΔT were determined from the density of the unexposed portion of the image forming element and that of the transparent support.

Results are shown in Table 1. In the table (e) and (c) are each represent an example according to the invention and a comparative example, respectively.

TABLE 1

| | d | D2 | D | S | | | | |
|---|---|---|---|---|---|---|---|---|
| | (μm) | (μm) | (μm) | (μm²) | S/D | ΔM | T | ΔT |
| 1-1 (c) | 0.2 | 0.05 | 0.25 | 31.65 | 126.61 | 0.02 | 47.6 | 0.01 |
| 1-2 (e) | 0.25 | 0.01 | 0.26 | 31.65 | 121.74 | 0.03 | 48.5 | 0.03 |
| 1-3 (e) | 0.3 | 0.05 | 0.35 | 31.65 | 90.44 | 0.05 | 49.1 | 0.04 |
| 1-4 (e) | 0.55 | 0.05 | 0.6 | 31.65 | 52.76 | 0.09 | 49.5 | 0.06 |
| 1-5 (e) | 0.7 | 0.15 | 0.85 | 31.65 | 37.24 | 0.15 | 49.7 | 0.07 |
| 1-6 (e) | 0.8 | 0.2 | 1 | 31.65 | 31.65 | 0.19 | 50.2 | 0.08 |
| 1-7 (e) | 0.85 | 0.15 | 1 | 31.65 | 31.65 | 0.18 | 50.4 | 0.08 |
| 1-8 (e) | 1 | 0.15 | 1.15 | 31.65 | 27.52 | 0.23 | 50.6 | 0.12 |
| 1-9 (e) | 1 | 0.15 | 1.15 | 19.63 | 17.07 | 0.24 | 50.5 | 0.12 |
| 1-10 (e) | 1.2 | 0.25 | 1.45 | 19.63 | 13.53 | 0.34 | 51.3 | 0.15 |
| 1-11 (e) | 1.3 | 0.25 | 1.55 | 19.63 | 12.66 | 0.48 | 51.7 | 0.18 |
| 1-12 (c) | 1.4 | 0.25 | 1.65 | 19.63 | 11.89 | 0.75 | 53.1 | 0.24 |

### Example 2

The following composition for forming the layer containing the laser light absorbing substance was kneaded and dispersed by a Henschel mixer and a sand mixer. Then 1.55 parts of a polyisocyanate compound (Coronate HX) was added to the composition and stirred by a dissolver to prepare a coating liquid for forming the layer containing the laser light absorbing substance.

The coating liquid was dispersed by an ultrasonic treatment and coated by an extrusion coating procedure on a transparent PET film of 100 μm, Lumirror T60 manufactured by Toray Co., Ltd., one side of which had been subjected to a corona discharge treatment. After drying, the coated layer was subjected to a calender treatment using a heating roller at a temperature of 100° C., a line pressure of 150 kg/cm and a transporting speed of 40 m/sec. The coated matter was aged at 60° C. for 72 hours. The coating amount of the composition was varied so that the dried thickness d of the layer was made as described in Table 2.

<Composition for forming the layer containing the laser light
absorbing substance>

| | | |
|---|---|---|
| Fe-Si-Al-Ni-Co ferromagnetic metal powder | 100 | parts |
| (Atomic ratio of Fe:Si:Al:Ni:Co = 100:1:4:3:5, | | |
| average major axis length: 0.14 μm) | | |
| Polyurethane resin (Vylon UR-82000) | 15.0 | parts |
| Chromium oxide (average particle diameter: | 5.0 | parts |
| 0.13 μm U-1, Nihon Kagaku Kogyo Co., Ltd.) | | |
| Phosphoric acid ester (Phosphanol RE610) | 3.0 | Parts |
| Methyl ethyl ketone | 105.0 | Parts |
| Toluene | 105.0 | parts |
| Cyclohexanone | 90.0 | parts |

A coating liquid for forming a protective layer having the following composition was prepared and dispersed by means of an ultrasonic dispersion. The coating liquid was coated on the above-mentioned layer containing the laser light absorbing substance by a reversal gravure coater. After drying the coated layer was aged at 60° C. for 72 hours. The coating amount of the composition was varied so that the dried thickness D2 of the protective layer was made as described in Table 2.

<Coating liquid for forming the protective layer>

| | | |
|---|---|---|
| Polyvinyl acetal resin (Elex BX-55, | 4.75 | parts |
| Sekisui Kagaku Kogyo Co., Ltd.) | | |
| Silica (Adomafine GC-5A) | 0.25 | parts |
| Ethanol | 100.0 | parts |
| Toluene | 95.0 | parts |

Besides, a solution of an urethane resin (above-mentioned) in a mixed solvent of toluene/methyl ethyl ketone/cyclohexanone=4/4/2 having a solid content of 5% was coated on the treated surface of a transparent PET film (T100E, Diafoil-Hoechst Co., Ltd.) by a bar coater to form a adhesive layer of 0.40 μm to prepare a peeling sheet. One side of the film had been previously subjected to a treatment on one side to give an adhering ability with the coated layer.

The surface of the protective layer of the above-mentioned image forming element and the adhesive surface of the peeling sheet were faces to each other and adhered by a heat-pressing treatment under the conditions of a roller temperature of 75° C., a transporting speed of 80 mm/sec. and a pressure of 6.0 kg/cm, to prepare an integrated image forming element with a peeling sheet. Thus prepared integrated image forming element was imagewise scanned by a light beam generated from the semiconductor laser LT090MD through the support. The laser light was focused at the interface between the layer containing the laser light absorbing substance and the transparent support. The sharpness of the edge portion of image, the reproducibility of the area of the condensed laser light beam S and the uniformity of the density in the imagewise exposed portion ΔOD of thus formed image on the support side were evaluated by the following procedure.

<Sharpness of Edge Portion: ΔM>

The evaluation was carried out in the same manner as in Example 1 except that exposure was carried out under conditions of a diameter of laser beam of 5.0 μm, light condensed area of 19.63 μm² and scanning pitch of 5.0 μm. or a diameter of laser beam of 7.5 μm, light condensed area of 44.16 μm and scanning pitch of 7.5 μm, and exposing energy of 270 mJ/cm².

<Reproducibility of Condensed Area of Laser Light: T, ΔT>

The evaluation was performed in the same manner as Example 1 except that the exposure was carried out under conditions of a laser light beam diameter of 5.0 μm, a of condensed light area of 19.63 μm² and a scanning pitch of 5.0 μm, or a laser light beam diameter of 7.5 μm, a of condensed light beam area of 44.16 μm², and a scanning pitch of 7.5 μm, and exposing energy of 270 mJ/cm², so that a halftone image composed of 50% round dot of 250 lines and a screen angle of 45° having a size of 100 mm×100 mm was formed by the scanning exposure.

<Uniformity of Density: ΔOD>

The image forming element was scanned by a laser beam having a Gaussian energy distribution under conditions of a laser beam diameter of 5.0 μm, a condensed light beam area of 19.63 μm² and a scanning pitch of 5.0 μm, or a laser beam diameter of 7.5 μm, a condensed light beam area of 44.16 μm² and a scanning pitch of 7.5 μm, and exposing energy of 270 mJ/cm² so that a halftone image composed of 0% round dot of 250 lines and a screen angle of 45° having a size of 100 mm×100 mm was formed by the scanning exposure. The transmission density of the image was measured at optionally selected 100 points by a densitometer (X-rite 310TR) in a visual density mode, and the fluctuation of the density (ΔOD) in the measured values was evaluated.

Thus obtained results are shown in Table 2.

TABLE 2

| | d | D2 | S | | | | | | |
|---|---|---|---|---|---|---|---|---|---|
| | (μm) | (μm) | (μm²) | S/D | S/d | ΔM | T | ΔT | ΔOD |
| 2-1(c) | 0.2 | 0.05 | 44.16 | 176.6 | 220.8 | 0.05 | 46.3 | 0.02 | 0.096 |
| 2-2(e) | 0.3 | 0.05 | 44.16 | 126.2 | 147.2 | 0.06 | 48.1 | 0.04 | 0.079 |
| 2-3(e) | 0.5 | 0.1 | 44.16 | 73.6 | 88.3 | 0.14 | 49.3 | 0.07 | 0.028 |
| 2-4(e) | 0.7 | 0.1 | 44.16 | 55.7 | 63.1 | 0.2 | 49.9 | 0.09 | 0.011 |
| 2-5(e) | 0.8 | 0.1 | 44.16 | 49.1 | 55.2 | 0.23 | 50.4 | 0.15 | 0.003 |
| 2-6(e) | 0.8 | 0.1 | 19.63 | 21.8 | 24.5 | 0.07 | 49.7 | 0.09 | 0.005 |
| 2-7(e) | 1.0 | 0.15 | 19.63 | 17.1 | 19.6 | 0.11 | 50.1 | 0.12 | 0.031 |
| 2-8(e) | 1.1 | 0.15 | 19.63 | 15.7 | 17.8 | 0.13 | 50.6 | 0.14 | 0.066 |
| 2-9(e) | 1.25 | 0.3 | 19.63 | 12.5 | 15.7 | 0.16 | 51.6 | 0.19 | 0.087 |
| 2-10(c) | 1.35 | 0.3 | 19.63 | 11.9 | 14.5 | 0.19 | 53.1 | 0.22 | 0.099 |

### Example 3

The image forming element 1-5 of Example 1 having a layer thickness D of 1 μm was imagewise exposed by scanning by a laser beam from the semiconductor laser LT090MD and an image was formed in the same manner as in Example 2. The laser beam was focused at the interface between the layer containing the laser light absorbing substance and the transparent support, and the area of condensed light of the laser beam S was varied. The sharpness and the reproducibility of the area S of condensed laser light were determine by the following procedure.

<Sharpness of the Edge of the Image: ΔM>

The scanning exposure was carried out by means of a laser beam having a Gaussian energy distribution and under conditions of a condensed laser light beam diameter of L μm, an area S μm² of condensed light, a scanning pitch of L μm and exposing energy of 250 mJ/cm², so as to form a halftone image composed of 95% square dots of 175 line and a screen angle of 0°. The image was formed in the same manner as in Example 2. The image formed was observed through a microscope to evaluate the maximum fluctuation width of the edge ΔM.

<Reproducibility of the Area of Condensed Light: T, ΔT>

The image forming element was imagewise exposed by scanning by means of a laser light beam rectangular with respect to the scanning direction having a Gaussian energy distribution under conditions of a laser beam diameter of L μm, a light condensed area of S μm², a scanning pitch of L μm and exposing energy of 250 mJ/cm², so as to form a halftone image having an area of 100×100 mm and composed of 50% round dots of 175 line and a screen angle of 45°. The average dot percentage T measured at optionally selected 100 points and the difference of the largest and the smallest value of the measured dot percentage ΔT were determined by a densitometer.

Thus obtained results are shown in Table 3.

TABLE 3

| | L (μm) | S (μm²) | S/D | ΔM | T | ΔT |
|---|---|---|---|---|---|---|
| 3-1 (c) | 5 | 10 | 10 | 0.16 | 47.9 | 0.02 |
| 3-2 (e) | 6 | 20 | 20 | 0.19 | 48.5 | 0.05 |
| 3-3 (e) | 8 | 35 | 35 | 0.28 | 50.9 | 0.09 |
| 3-4 (e) | 10 | 60 | 60 | 0.34 | 50.7 | 0.11 |
| 3-5 (e) | 12 | 72 | 72 | 0.31 | 49.8 | 0.13 |
| 3-6 (e) | 12 | 96 | 96 | 0.32 | 49.1 | 0.15 |
| 3-7 (e) | 15 | 120 | 120 | 0.79 | 48.3 | 0.18 |

### Example 4

The image forming element 2-5 prepared in Example 2 having a layer thickness D of 0.9 μm was imagewise scanned by a laser beam generated from the semiconductor laser LT090MD and an image was formed in the same manner as in Example 2. The laser beam was focused at the interface between the layer containing the laser light absorbing substance and the transparent support, and the area of condensed laser light S was varied. The sharpness of edge of the image formed on the support, the reproducibility of the area of condensed laser light S and the uniformity of the density ΔD at the imagewise exposed portion were evaluated by the following procedure.

<Sharpness of Edge of the Image: ΔM>

The image forming element was exposed to a laser beam having a Gaussian energy distribution by scanning under conditions of a diameter of the condensed laser beam of L μm a scanning pitch of L×2 μm and exposing energy of 280 mJ/cm². Thus obtained image was observed by a microscope to determined the maximum fluctuation width of the edge of the image ΔM.

<Reproducibility of the Area of Condensed Laser Light: T, ΔT>

The image forming element was exposed by scanning to a laser light beam having a Gaussian energy distribution and a form of rectangular with respect to the scanning direction under conditions of a diameter of the laser light beam of L μm, an area of condensed laser light beam of S μm², a scanning pitch of L m and exposing energy of 300 mJ/cm², so as to form a halftone image composed of 95% square dots of 175 line and angle of 0°. Thus obtained image was observed by a microscope to determine the maximum fluctuation width of the edge of image ΔM.

<Reproducibility of the Area of Condensed Laser Light Beam: T, ΔT>

The image forming element was exposed by scanning to a laser light beam having a Gaussian energy distribution and a form of rectangular with respect to the scanning direction under conditions of a diameter of the laser light beam of L μm, an area of condensed light beam of S μm², a scanning pitch of L μm and exposing energy of 300 mJ/cm², so as to form a halftone image composed of 50% round dots of 250 line with a screen angle of 45° and having a size of 100 mm×100 mm. The average dot percentage T and the ΔT were measured by a densitometer at optionally selected 100 points in the formed halftone image.

The image forming element was exposed by scanning to a laser light beam having a Gaussian energy distribution and a form of rectangular with respect to the scanning direction under conditions of a diameter of the laser light beam of L μm, an area of condensed light beam of S μm², a scanning pitch of L μm and exposing energy of 300 mJ/cm², so as to form a halftone image composed of 0% round dots of 250 line with an angle of 45° and having a size of 100 mm×100 mm. The transmission density was measured by a densitometer at optionally selected 100 points in the formed halftone image, and the fluctuation of the density ΔD were determined.

Thus obtained results are shown in Table 4.

TABLE 4

| | L | S | | | | | | |
|---|---|---|---|---|---|---|---|---|
| | (μm) | (μm²) | S/D | S/d | ΔM | T | ΔT | ΔOD |
| 4-1 (c) | 5 | 10 | 10 | 12.5 | 0.14 | 47.2 | 0.03 | 0.102 |
| 4-2 (e) | 6 | 15 | 15 | 18.75 | 0.18 | 48.7 | 0.05 | 0.031 |
| 4-3 (e) | 8 | 30 | 30 | 37.5 | 0.26 | 50.7 | 0.07 | 0.01 |
| 4-4 (e) | 12 | 60 | 60 | 75 | 0.21 | 50.6 | 0.11 | 0.023 |
| 4-5 (e) | 12 | 96 | 96 | 120 | 0.29 | 50.1 | 0.12 | 0.021 |
| 4-6 (e) | 15 | 110 | 110 | 137.5 | 0.32 | 49.5 | 0.16 | 0.072 |
| 4-7 (e) | 17 | 130 | 130 | 162.5 | 0.85 | 48.7 | 0.18 | 0.086 |

### Example 5

The following composition for forming the layer containing the laser light absorbing substance was kneaded and dispersed by a Henschel mixer and a sand mixer. Then 5.90 parts of a polyisocyanate compound, Coronate 3041, effective component content of 50%, manufactured by Nihon Polyurethane Industry Co. Ltd., was added to the composition and stirred to prepare a coating liquid for forming the layer containing the laser light absorbing substance.

The coating liquid was subjected to ultrasonic dispersion and coated and dried by an extrusion coating method on a transparent polyethylene terephthalate film Lumirror T60, manufactured by Toray Co., Ltd., which had a thickness of 100 μm and was subjected to a corona discharge treatment on one side thereof. After drying, the coated layer was subjected to a calender treatment using a heat roller under conditions of a temperature of 90° C., a line pressure of 150 kg/cm and a transporting speed of SOm/sec. and an aging at 60° C. for 72 hours. The coating amount of the composition was varied so that the dried thickness d of the layer was made as described in Table 5.

<Composition for Forming the Layer Containing the Laser Light Absorbing Substance>

| | | |
|---|---|---|
| Fe-Al ferromagnetic metal powder | 100 | parts |
| (atomic ratio of Fe:Al = 100:4, | | |
| average length of major axis: 0.14 μm) | | |
| Vinyl chloride resin | 10.0 | parts |
| (MR-110, Nihon Zeon Co., Ltd.) | | |
| Polyurethane resin (Vylon UR-8200) | 5.0 | parts |
| Phosphoric acid ester (Phosphanol RE610) | 3.0 | parts |
| Methyl ethyl ketone | 105.0 | parts |
| Toluene | 105.0 | parts |
| Cyclohexanone | 90.0 | parts |

Thereafter, a protective layer coating liquid having the following composition was prepared and subjected to a ultrasonic dispersion treatment. The coating liquid was coated by a extrusion coating method on the above-mentioned layer containing the laser light absorbing substance. After drying, the coated element was aged at 60° C. for 72 hours. The coating amount of the protective layer was varied so that the thickness of the protective layer D2 was as shown in Table 5.

<Coating liquid for forming protective layer>

| | | |
|---|---|---|
| Acryl resin | 8.4 | parts |
| (Dianal BR77, Motsubishi Rayon Co., Ltd.) | | |
| Silica sol (average particle diameter: 0.025 μm) | 0.5 | parts |
| (Organo silica sol CX-SZ) | | |
| Polyethylene wax dispersion (effective component | 2.0 | parts |
| content 15% by weight, Microflat CE-155, | | |
| Koyo Kagaku Co., Ltd.) | | |
| Carbodiimide group-containing compound | 2.0 | parts |
| (effective component content 40% by weight, | | |
| Carbodilite V-03, Nihon Shokubai Co., Ltd.) | | |
| Toluene | 80.0 | parts |
| Cyclohexanone | 7.1 | parts |

Thus obtained image forming elements were each imagewise exposed by scanning from the support side using a circular laser light beam, such as that shown in FIG. 4(b), generated by a semiconductor laser (LT090MD manufactured by Sharp Co., Ltd., principal wavelength: 830 nm). The laser light was focused at the interface between the layer containing the laser light absorbing substance and the support. Then the adhesive surface of an adhesive tape, Scotch No. 845 Book tape, manufactured by 3M co., Ltd., was surfaced to the surface of the layer containing the laser light absorbing substance side of the image forming element and contacted by pressing treatment by a pressure roller under the conditions of a transporting speed of 30 mm/sec., and a pressure of 3.0 kg/cm, so that no bubble was formed between the image forming element and the adhesive tape. The image forming element was fixed on a flat plate and peel the adhesive tape under the conditions of a peeling angle of 90 and a peeling speed of 40 mm/second, to take out the exposed portion to the adhesive tape side to form an image.

The edge sharpness and the reproducibility of the condensed light spot diameter L of the image formed on the support were evaluated according to the following method.

<Sharpness of the Edge Portion: ΔM>

The element was exposed by scanning under the conditions of a beam diameter of condensed laser light of 6.35 μm, a scanning pitch of 12.7 μm and exposing energy of 300 mJ/cm². The formed image was microscopically observed, and the maximum deviation width ΔM of the image edge was measured and evaluated as shown in FIG. 11.

<Reproducibility of the Diameter of Condensed Laser Light: N, ΔN>

A line image having a width of 19.05 μm and a length of 100 mm was given by scanning exposure to the element under the conditions of a condensed laser beam diameter of 6.35 μm, a scanning pitch of 6.35 μm and exposing energy of 300 Jm/cm². The width of the formed image was microscopically measured at optionally selected 100 points and the average value of the width N and the difference between the maximum width and the minimum width ΔN were determined.

Thus obtained results are shown in Table 5.

TABLE 5

| | d | D2 | D | | | | | |
|---|---|---|---|---|---|---|---|---|
| | (μm) | (μm) | (μm) | S/D | L/D | ΔM | N | ΔN |
| 5-1 | 0.4 | 0.05 | 0.45 | 70.7 | 14.1 | 0.09 | 20.05 | 0.24 |
| 5-2 | 0.5 | 0.05 | 0.55 | 57.5 | 11.5 | 0.09 | 19.68 | 0.26 |
| 5-3 | 0.7 | 0.1 | 0.8 | 39.6 | 7.9 | 0.13 | 19.25 | 0.31 |
| 5-4 | 0.7 | 0.2 | 0.9 | 35.2 | 7.1 | 0.15 | 18.67 | 0.36 |
| 5-5 | 0.8 | 0.15 | 0.95 | 33.3 | 6.7 | 0.16 | 18.99 | 0.41 |
| 5-6 | 0.8 | 0.25 | 1.05 | 30.1 | 6 | 0.2 | 18.56 | 0.43 |
| 5-7 | 1 | 0.15 | 1.15 | 27.5 | 5.5 | 0.25 | 18.32 | 0.56 |
| 5-8 | 1.2 | 0.3 | 1.5 | 21.1 | 4.2 | 0.34 | 18.05 | 0.74 |

### Example 6

The following compositions A and B for forming the layer containing the laser light absorbing substance are separately kneaded and dispersed by a Henschel mixer and a sand mill. Then the composition A and B and the polyisocyanate compound (above-mentioned) were mixed in a ratio of 100:2.39:0.37 and stirred by a dissolver to prepare a coating liquid for forming the layer containing the laser light absorbing substance.

The coating liquid was dispersed by an ultrasonic treatment and coated by an extrusion coating procedure on a transparent PET film, one side of which had been subjected to a corona discharge treatment. After drying, the coated layer was subjected to a calender treatment using a heating roller at a temperature of 100° C., a line pressure of 150 kg/cm and a transporting speed of 60 m/sec. The coated matter was aged at 60° C. for 168 hours. The coating amount of the composition was varied so that the dried thickness d of the layer was made as described in Table 3.

<Composition for Forming the Layer Containing the Laser Light Absorbing Substance>

<Composition for forming the layer containing the laser light
absorbing substance>

| Solution A | | |
|---|---|---|
| Fe-Al ferromagnetic metal powder | 100 | parts |
| Polyurethane resin (Vylon UR-8200) | 10.0 | parts |
| Polyester resin (Vylon 280) | 5.0 | parts |
| Phosphoric acid ester (Phosphanol RE610) | 3.0 | parts |
| Methyl ethyl ketone | 105.0 | parts |
| Toluene | 105.0 | parts |
| Cyclohexanone | 90.0 | parts |
| Solution B | | |
| α-alumina (average particle diameter: 0.18 μm, | 100 | parts |
| High purity alumina HIT60G, | | |
| Sumitomo Kagaku Co., Ltd.) | | |
| Polyurethane resin (Vylon UR-8700) | 15 | parts |
| Phosphoric acid ester (Phosphanol RE610) | 3.0 | parts |
| Methyl ethyl ketone | 41.3 | parts |
| Toluene | 41.3 | parts |
| Cyclohexanone | 35.4 | parts |

A solution of the phenoxy resin PKHH in a mixed solvent in a ratio of toluene/cyclohexanone of 6/4 having a solid content of 2.5% was coated by a reversal bar coater on the above-mentioned layer containing the laser light absorbing substance and dried, and further aged at 60° C. for 72 hours. The coating amount of the protective layer was varied so that the thickness of the protective layer D2 was as shown in Table 3.

Besides, an adhesive layer composition having the following composition was coated on the treated surface of a transparent PET film (T100E, Diafoil-Hoechst Co., Ltd.) by a bar coater to form a adhesive layer of 0.40 μn to prepare a peeling sheet. The film had been previously subjected to a treatment on one side to give a easily adhering ability.

<Adhesive layer composition>

| | | |
|---|---|---|
| Urethane resin (Nipporan 3109, | 4.90 | parts |
| Nihon Polyurethane Industry Co., Ltd.) | | |
| Silicone resin particle (Tospar 105, | 0.10 | parts |
| Toshiba Silicone Co., Ltd.) | | |
| Toluene | 42.75 | parts |
| Methyl ethyl ketone | 42.75 | parts |
| Cyclohexanone | 9.50 | parts |

The surface of the protective layer of the image forming element and the surface of the adhesive layer of the peeling sheet were faced and adhered to each other by a heat-pressing treatment under the conditions of a roller temperature of 70° C., a transporting speed of 180 mm/second and a pressure of 6.0 kg/cm, to prepare an integrated image forming element. The integrated image forming element was imagewise exposed from the support by means of the semiconductor laser LT090MD. The laser light was focused at the interface between the layer containing the laser light absorbing substance and the transparent support.

Then the element was fixed on a flat plate, and the peeling sheet was peeled under the conditions of a peeling angle of 180° and a peeling speed of 50 mm/second, to take out the image to the peeling sheet side to form an image.

The sharpness of the edge of the image, the reproducibility of the image of the diameter of the condensed laser light and the uniformity of the density of the imagewise exposed portion ΔOD were determined by the following procedures.

<Sharpness of Edge Portion: ΔM>

The evaluation was carried out in the same manner as in Example 5 except that the exposing energy was changed to 290 mJ/cm².

<Reproducibility of Condensed Diameter of Laser Light: N, ΔN>

The evaluation was carried out in the same manner as in Example 5 except that that the exposing energy and the width of the line image to be formed were changed to 290 mJ/cm² and 12.7 μm, respectively.

<Uniformity of Density: ΔOD>

The image forming element was imagewise exposed by scanning under the conditions of a beam diameter of 6.35 μm, an area of the condensed light beam of 31.65 μm a scanning pitch of 6.35 μm and exposing energy of 290 mJ/cm², so the that an uniform image having a size of 100 mm×100 mm was formed. The transmission density of the image was measured at optionally selected 100 points by a densitometer, X-rite 310TR, manufactured by X-rite Co., Ltd., in a visual density mode and the fluctuation of the density (ΔOD) was evaluated according to the value of (the maximum value among the densities at the measured points)−(the minimum value among the densities at the measured points).

### Example 7

An integrated image forming element adhered with a peeling sheet having an image forming layer thickness of 0.8 μm was prepared in the same manner as in Example 6 except that 10 parts of a laser light absorbing dye (CY-10, manufactured by Nihon Kayaku Co., Ltd.) was added to the Composition A for forming the layer containing the laser light absorbing substance of Example 6-3. An image was formed and evaluated in the same manner as in Example 6.

Results are shown in Table 6. The S/D values of all the samples of Examples 6 and 7 were within the range of from 12 to 145, according to the invention.

TABLE 6

| | d | D2 | | | | | | |
|---|---|---|---|---|---|---|---|---|
| | (μm) | (μm) | S/D | L/d | ΔM | N | ΔN | ΔOD |
| 6-1 | 0.4 | 0.05 | 70.3 | 15.9 | 0.07 | 13.8 | 0.16 | 0.061 |
| 6-2 | 0.5 | 0.1 | 52.8 | 12.7 | 0.11 | 13.3 | 0.23 | 0.042 |
| 6-3 | 0.7 | 0.1 | 39.6 | 9.1 | 0.15 | 13 | 0.32 | 0.021 |
| 6-4 | 0.8 | 0.1 | 35.2 | 7.9 | 0.15 | 12.8 | 0.35 | 0.011 |
| 6-5 | 0.9 | 0.1 | 31.7 | 7.1 | 0.17 | 12.6 | 0.38 | 0.015 |
| 6-6 | 1 | 0.1 | 28.8 | 6.4 | 0.21 | 12.4 | 0.44 | 0.022 |
| 6-7 | 1.1 | 0.3 | 22.6 | 5.8 | 0.25 | 12 | 0.51 | 0.048 |
| 6-8 | 1.2 | 0.3 | 21.1 | 5.3 | 0.3 | 11.6 | 0.62 | 0.061 |
| 7 | 0.7 | 0.1 | 39.6 | 9.1 | 0.12 | 13.2 | 0.14 | 0.018 |

### Example 8

The following compositions A and B for forming a layer containing the laser light absorbing substance were each kneaded and dispersed by a Henschel mixer and a sand mill. The foregoing compositions and B and a polyisocyanate (Coronate HX) were mixed in a weight ratio of 100:2.39:0.37 and stirred by a dissolver to prepare a coating liquid for forming the layer containing the laser light absorbing substance.

The coating liquid was dispersed by an ultrasonic treatment and coated and dried by an extrusion coating procedure on a transparent PET film of 100 Mm (Lumirror T60), one side of which had been subjected to a corona discharge treatment. After drying, the coated layer was subjected to a calender treatment using a heating roller at a temperature of 100° C., a line pressure of 150 kg/cm and a transporting speed of 60 m/sec. The coated matter was aged at 60° C. for 72 hours. Thus a layer containing the laser light absorbing substance having a thickness of 0.80 μm. The average major axis length R1 of Fe—Al ferromagnetic metal powder used in the solution A and B, and the average particle diameter R2 of a-alumina contained in the solution B are shown in Table 5.

<Composition for Forming the Layer Containing the Laser Light Absorbing Substance>

Solution A

| | | |
|---|---|---|
| Fe-Al ferromagnetic metal powder | 100 | parts |
| (atomic ratio Fe:Al = 100:3) | | |
| Polyurethane resin (Vylon UR-8200) | 10.0 | parts |
| Polyester resin (Vylon 280) | 5.0 | parts |
| Phosphoric acid ester (Phosphanol ER610) | 3.0 | parts |
| Methyl ethyl ketone | 105.0 | parts |
| Toluene | 105.0 | parts |
| Cyclohexanone | 90.0 | parts |

Solution B

| | | |
|---|---|---|
| α-alumina | 100 | parts |
| Polyurethane resin (Vylon UR-8700) | 15 | parts |
| Phosphoric acid ester (Phosphanol RE610) | 3.0 | parts |
| Methyl ethyl ketone | 41.3 | parts |
| Toluene | 41.3 | parts |
| Cyclohexanone | 35.4 | parts |

Then the following protective layer forming coating liquid was prepared and dispersed by means of an ultrasonic treatment. Thus obtained liquid was coated on the above-obtained layer containing the laser light absorbing substance by a reversal bar coater and dried. Thereafter, the layer was aged at 60° C. for 72 hours. Thus protective layer having a thickness of 0.15 μm was prepared.

<Coating liquid for forming the protective layer>

| | | |
|---|---|---|
| Phenoxy resin (PKHH) | 7.65 | parts |
| Polyethylene wax dispersion | | |
| (Microflat CE-155) | 0.35 | parts |
| Polyisocyanate compound (Coronate HX) | 2.0 | parts |
| Toluene | 120.0 | parts |
| Cyclohexanone | 80.0 | parts |

On the other hand, the following adhesive layer composition was coated on a surface of a transparent PET film, T-100E manufactured by Diafoil-Hoechst Co., Ltd., which treated so as to have a adhesive ability to the coated layer, by a bar coater and dried to prepare a peeling sheet having a adhesive layer with a thickness of 1.30 μm.

<Adhesive layer composition>

| | | |
|---|---|---|
| Urethane resin (Nippollane 3109, | 4.90 | parts |
| Nihon Polyurethane Co., Ltd.) | | |
| Silicone resin particle (Tospar 120) | 0.10 | parts |
| Toluene | 42.75 | parts |
| Methyl ethyl ketone | 42.75 | parts |
| Cyclohexanone | 9.50 | parts |

Then the protective layer surface of the image forming element and the surface of adhesive layer of the peeling sheet were faced and adhered to each other by a heat-pressing treatment the same as in Example 6 prepare an integrated image forming element. The integrated image forming element was imagewise exposed from the transparent support side by scanning by means of a YAG laser, DPY521C-NP manufactured by Adlas Co., ltd., having an output of 4000 mW, and a principal wavelength at 1064 nm. The laser beam was focused at the interface between the layer containing the laser light absorbing substance and the transparent support.

The image forming element was fixed on a flat plate and the peeling sheet was peeled in the same manner as in Example 6 to take out the exposed portion to the peeling sheet side to form an image.

The edge sharpness, the reproducibility of the condensed diameter of laser light L and the density D of the imagewise exposed portion of the image formed on the support were evaluated in the following procedure.

<Sharpness of Edge: ΔM>

The scanning exposure was carried out by a circular laser light beam having a Gaussian energy distribution as shown in FIG. 4(b) under conditions of a beam diameter of 10.0 μm, a scanning pitch of 30.0 μm and exposing energy of 230 mJ/cm². The evaluation was performed in the same manner as in Example 5.

<Reproducibility of the Condensed Diameter of Laser Light: N, ΔN>

The scanning exposure was carried out by a circular laser light beam having a Gaussian energy distribution under conditions of a beam diameter of 10 μm, a scanning pitch of 10 μm and exposing energy of 230 mJ/cm² so that a line image having a width of 30 μm and a length of 100 mm was formed. The measurement was performed in the same manner as in Example 5.

<Density of Exposed Portion: OD, ΔODₘᵢₙ>

The scanning exposure was carried out by a circular laser light beam having a Gaussian energy distribution under conditions of a beam diameter of 10 μm, a scanning pitch of 10 μm and exposing energy of 230 mJ/cm² so that an uniform image having a size of 100 mm×100 mm was formed. The transmission density of the formed image was measured at optionally selected 100 points by a densitometer (above-mentioned) at the visual density mode, and the average value of the density DO and the difference of the maximum value and the minimum value among the measured densities ΔODE were determined. The average value OD is an average of the difference of the actual measured density and the density of the support.

### Example 9

An image forming element integrated with a peeling layer was prepared in the same manner as in Example 7 except that 5 parts of a laser light absorbing dye, IRG-022 manufactured by Nihon Kayaku Co., Ltd., was added to the composition A for forming the layer containing the laser light absorbing substance of example 8-7. Thus prepared element was evaluated in the same manner as in Example 8.

Thus obtained results are shown in Table 7.

TABLE 7

| | R1 | R2 | R | | | | | | |
|---|---|---|---|---|---|---|---|---|---|
| | (μm) | (μm) | (μm) | L/R | ΔM | N | ΔN | OD | ΔODₘᵢₙ |
| 8-1 | 0.08 | 0.1 | 0.081 | 123.5 | 0.05 | 10 | 0.13 | 0.071 | 0.012 |
| 8-2 | 0.09 | 0.15 | 0.093 | 107.7 | 0.07 | 10.1 | 0.16 | 0.056 | 0.01 |
| 8-3 | 0.15 | 0.1 | 0.148 | 67.7 | 0.12 | 10.1 | 0.25 | 0.024 | 0.005 |
| 8-4 | 0.15 | 0.17 | 0.194 | 51.6 | 0.15 | 10.2 | 0.31 | 0.018 | 0.004 |

(50%)

0.24

(50%)

| | | | | | | | | | |
|---|---|---|---|---|---|---|---|---|---|
| 8-5 | 0.18 | 0.17 | 0.18 | 55.7 | 0.15 | 10.2 | 0.32 | 0.017 | 0.004 |
| 8-6 | 0.2 | 0.17 | 0.199 | 50.4 | 0.18 | 10.2 | 0.38 | 0.006 | 0.003 |
| 8-7 | 0.24 | 0.17 | 0.237 | 42.3 | 0.21 | 10.2 | 0.45 | 0.004 | 0.003 |
| 8-8 | 0.24 | 0.17 | 0.36 | 27.7 | 0.37 | 10.3 | 0.79 | 0.008 | 0.013 |

(50%)

0.50

(50%)

| | | | | | | | | | |
|---|---|---|---|---|---|---|---|---|---|
| 8-9 | 0.3 | 0.25 | 0.298 | 33.6 | 0.24 | 10.3 | 0.54 | 0.005 | 0.009 |
| 8-10 | 0.5 | 0.3 | 0.49 | 20.4 | 0.51 | 10.3 | 1.06 | 0.009 | 0.024 |
| 9 | 0.24 | 0.17 | 0.237 | 42.3 | 0.2 | 10.2 | 0.43 | 0.013 | 0.008 |

### Example 10

The following compositions A and B for forming a layer containing the laser light absorbing substance were each kneaded and dispersed by a Henschel mixer and a sand mill. The foregoing compositions and B and a polyisocyanate, Coronate HX, were mixed in a weight ratio of 100:2.39:0.37 and stirred by a dissolver to prepare a coating liquid for forming the layer containing the laser light absorbing substance.

The coating liquid was dispersed by an ultrasonic treatment and coated by an extrusion coating procedure on a transparent PET film of 100 μm, one side of which had been subjected to a corona discharge treatment. After drying, the coated layer was subjected to a calender treatment using a heating roller at a temperature of 100° C., a line pressure of 150 kg/cm and a transporting speed of 60 m/sec. The coated matter was aged at 60° C. for 72 hours. Thus a layer containing the laser light absorbing substance was formed, which had a thickness of 0.7 μm. The average major axis length R1 of Fe—Al ferromagnetic metal powder used in the solution A and B, and the average particle diameter R2 of α-alumina contained in the solution B are shown in Table 8.

<Composition for Forming the Layer Containing the Laser Light Absorbing Substance>

Solution A

| | | |
|---|---|---|
| Fe-Al ferromagnetic metal powder | 100 | parts |
| (atom number ratio = 100:3) | | |
| Polyurethane resin (Vylon UR-8200) | 10.0 | parts |
| Polyester resin (Vylon 280) | 5.0 | parts |
| Phosphoric acid ester (Phosphanol RE610) | 3.0 | parts |
| Methyl ethyl ketone | 105.0 | parts |
| Toluene | 105.0 | parts |
| Cyclohexanone | 90.0 | parts |

Solution B

| | | |
|---|---|---|
| α-alumina (High purity alumina HIT60G, | 100 | parts |
| Sumitomo Kagaku Co., Ltd.) | | |
| Polyurethane resin (Vylon UR-8700) | 15 | parts |
| Phosphoric acid ester (Phosphanol RE610) | 3.0 | parts |
| Methyl ethyl ketone | 41.3 | parts |
| Toluene | 41.3 | parts |
| Cyclohexanone | 35.4 | parts |

Then the following protective layer forming coating liquid was prepared and dispersed by means of an ultrasonic treatment. Thus obtained liquid was coated on the above-obtained layer containing the laser light absorbing substance by a reversal bar coater and dried. Thereafter, the layer was aged at 60° C. for 72 hours. Thus protective layer having a thickness D2 of 0.20 μm was prepared.

<Coating liquid for forming the protective layer>

| | | |
|---|---|---|
| Phenox resin (PKHH) | 1.80 | parts |
| Polyethylene wax dispersion (Microflat CE-155) | 0.315 | parts |
| Polyisocyanate compound (Coronate HX) | 0.48 | parts |
| Ester modified by rosin (Superester A-100, | 0.60 | parts |
| Arakawa Kagaku Kogyo Co., Ltd.) | | |
| Fluorized compound (Surfron S-383) | 0.033 | parts |
| Toluene | 53.062 | parts |
| Cyclohexanone | 38.71 | parts |

On the other hand, the following adhesive layer composition was coated by a bar coater on a surface, which treated so as to have a adhesive ability, of a transparent PET film, T100E manufactured by Diafoil-Hoechst Co., Ltd., having a thickness of 38 μm, and dried to prepare a peeling sheet having a adhesive layer with a thickness of 1.30 μm.

<Adhesive layer composition>

| | | |
|---|---|---|
| Urethane resin (above-mentioned) | 4.90 | parts |
| Silicone resin particle (Tospar 105) | 0.10 | parts |
| Toluene | 42.75 | parts |
| Methyl ethyl ketone | 42.75 | parts |
| Cyclohexanone | 9.50 | parts |

Then the protective surface of the image forming element and the surface of adhesive layer of the peeling sheet were faced and adhered to each other by a heat-pressing treatment the same as in Example 6 prepare an integrated image forming element. The integrated image forming element was imagewise exposed from the transparent support side by scanning by means of the YAG laser DPY521C-NP. The laser beam was focused at the interface between the layer containing the laser light absorbing substance and the transparent support.

The image forming element was fixed on a flat plate and the peeling sheet was peeled in the same manner as in Example 6 to take out the exposed portion to the peeling sheet side to form an image.

The edge sharpness, the reproducibility of the area of the condensed light beam and the density Dn of the imagewise exposed portion of the image formed on the support were evaluated in the following procedure.

<Sharpness of Edge: ΔM>

The scanning exposure was carried out under conditions of a beam diameter of 5.0 μm, a condensed light beam area of 19.63 μm² and a scanning pitch of 15.0 μm or a beam diameter of 10.0 μm, a condensed light beam area of 78.54 μm and a scanning pitch of 30.0 μm, and exposing energy of 190 mJ/cm². The evaluation was performed in the same manner as in Example 1.

<Reproducibility of the Condensed Light Beam Area: T, ΔT>

The scanning exposure was carried out by a laser beam having a Gaussian energy distribution under conditions of a beam diameter of 5.0 μm, a condensed light beam area of 19.63 μm² and a scanning pitch of 5.0 μm, or a beam diameter of 10.0 μm, a condensed light beam area of 78.54 μm² and a scanning pitch of 10.0 μm, and exposing energy of 190 mJ/cm² so that an 50% halftone image composed of round dot of 175 line and a screen angle of 45°. The measurement was performed in the same manner as in Example 1.

<Density of Exposed Portion: OD, ΔODₘᵢₙ>

The scanning exposure was carried out by a laser beam having a Gaussian energy distribution under conditions of a beam diameter of 5.0 μm, a condensed light beam area of 19.63 μm² and a scanning pitch of 5.0 μm, or a beam diameter of 10 μm, a condensed light beam area of 78.45 μm² and a scanning pitch of 10 μm, and exposing energy of 230 mJ/cm² so that an 0% halftone image having a size of 100 mm×100 mm was formed. The transmission density of the formed image was measured at optionally selected 100 points by the densitometer X-rite 310TR at the visual density mode, and the average value of the density DO and the difference of the maximum value and the minimum value among the measured densities ΔODₘᵢₙ were determined.

Thus obtained results are shown in Table 8.

TABLE 8

| | R1 | R2 | R | S | | | | | | |
|---|---|---|---|---|---|---|---|---|---|---|
| | (μm) | (μm) | (μm) | (μm²) | S/R | ΔM | T | ΔT | OD | ΔODₘᵢₙ |
| 10-1 | 0.06 | 0.15 | 0.064 | 78.5 | 1221.1 | 0.05 | 51.9 | 0.04 | 0.088 | 0.006 |
| 10-2 | 0.09 | 0.17 | 0.094 | 78.5 | 386.8 | 0.09 | 51.1 | 0.05 | 0.07 | 0.005 |
| 10-3 | 0.15 | 0.18 | 0.151 | 78.5 | 518.4 | 0.13 | 50.2 | 0.07 | 0.028 | 0.003 |
| 10-4 | 0.15 (50%) | 0.18 | 0.223 | 78.5 | 352.2 | 0.17 | 50.2 | 0.08 | 0.014 | 0.002 |
| | 0.30 (50%) | | | | | | | | | |
| 10-5 | 0.24 | 0.18 | 0.237 | 78.5 | 331 | 0.18 | 50.1 | 0.07 | 0.01 | 0.002 |
| 10-6 | 0.24 | 0.18 | 0.237 | 19.63 | 82.8 | 0.16 | 50.1 | 0.05 | 0.007 | 0.001 |
| 10-7 | 0.3 | 0.18 | 0.294 | 19.63 | 66.7 | 0.21 | 50.4 | 0.07 | 0.014 | 0.003 |
| 10-8 | 0.30 (50%) | 0.18 | 0.194 | 19.63 | 101 | 0.35 | 50.6 | 0.09 | 0.02 | 0.004 |
| | 0.09 (50%) | | | | | | | | | |
| 10-9 | 0.5 | 0.2 | 0.486 | 19.63 | 40.4 | 0.48 | 50.9 | 0.13 | 0.023 | 0.003 |
| 10-10 | 0.6 | 0.3 | 0.586 | 19.63 | 33.5 | 0.51 | 51.9 | 0.17 | 0.028 | 0.003 |

### Example 11

The image forming element 5-5 of Example 5 having a layer thickness D of 0.95 μm was imagewise scanned by a laser light beam from the semiconductor laser TL090MD and an image was formed in the same manner as in Example 5. The laser beam was focused at the interface between the layer containing the laser light absorbing substance and the transparent support, and the spot diameter of the laser beam L was varied. The sharpness and the reproducibility of the diameter L of condensed laser light were determine by the following procedure.

<Sharpness of the Edge of the Image: ΔM>

The scanning exposure was carried out by means of a laser beam having a Gaussian energy distribution and under conditions of a condensed laser light beam diameter of L μm, a scanning pitch of L μm and exposing energy of 250 mJ/cm². The image formed was observed through a microscope to evaluate the maximum fluctuation width of the edge ΔM.

<Reproducibility of the Condensed Diameter Width of Laser Light: N, ΔN>

The scanning exposure was performed by a laser beam having a Gaussian energy distribution under conditions of a diameter of condensed laser beam of L μm, a scanning pitch of L μm and exposing energy of 250 mJ/cm², so that a line image having a width of L×3 μm and a length of 100 mm. The width of the line image was measured by a microscope at optionally selected 100 points and an average of the width N and a difference of between the values of the largest and the smallest width of the line image ΔN were determined.

Thus obtained results are shown in Table 9.

TABLE 9

| | L (μm) | L/D | ΔM | N | ΔN |
|---|---|---|---|---|---|
| 11-1 | 4 | 4.21 | 0.11 | 12.54 | 0.24 |
| 11-2 | 6 | 6.32 | 0.17 | 17.99 | 0.39 |
| 11-3 | 8 | 8.42 | 0.17 | 23.87 | 0.41 |
| 11-4 | 10 | 10.53 | 0.24 | 29.79 | 0.5 |
| 11-5 | 12 | 12.63 | 0.35 | 35.62 | 0.72 |

### Example 12

The image forming element 1-5 having a layer thickness D of 1.0 μm was imagewise exposed by scanning by a laser beam from the semiconductor laser LT090MD and an image was formed in the same manner as in Example 3. The laser beam was focused at the interface between the layer containing the laser light absorbing substance and the transparent support, and the diameter of condensed light of the laser beam L was varied. The sharpness of edge of the image, the reproducibility of the diameter of condensed laser light L and the uniformity of the density at the imagewise exposed portion were evaluated by the following procedures.

<Sharpness of Edge of the Image>

The image forming element was exposed to a laser beam having a Gaussian energy distribution by scanning under conditions of a diameter of the condensed laser beam of L μm, a scanning pitch of L×2 μm and exposing energy of 280 mJ/cm². Thus obtained image was observed by a microscope to determined the maximum fluctuation width of the edge of the image ΔM.

<Reproducibility of the Diameter Width of Condensed Laser Light>

The image forming element was imagewise exposed to a laser light beam having a Gaussian energy distribution under conditions of a condensed laser beam diameter of L gm and exposing energy of 280 mJ/cm², so as to form an image having a width of L×2 μm and a length of about 10 cm. Thus obtained image was observed by a microscope at optionally selected 100 points and the average width of the image N and the difference of the largest and the smallest value of the width AN were determined.

<Uniformity of the Density: ΔD>

The image forming element was imagewise exposed to a laser light beam having a Gaussian energy distribution under conditions of a condensed laser beam diameter of L μm and exposing energy of 280 mJ/cm², so as to form an uniform image having the size of 10 cm×10 cm. The transmission density of the image was measured at optionally selected 100 points by a densitometer, and the fluctuation of the density ΔD was evaluated.

Thus obtained results are shown in Table 10.

TABLE 10

| | L (μm) | L/d | ΔM | N | ΔN | ΔOD |
|---|---|---|---|---|---|---|
| 12-1 | 5 | 5.56 | 0.13 | 10.68 | 0.27 | 0.071 |
| 12-2 | 6 | 6.67 | 0.16 | 11.94 | 0.31 | 0.023 |
| 12-3 | 8 | 8.89 | 0.17 | 16.03 | 0.35 | 0.009 |
| 12-4 | 10 | 11.11 | 0.22 | 20.16 | 0.26 | 0.012 |
| 12-5 | 12 | 13.33 | 0.32 | 24.38 | 0.64 | 0.024 |

### Example 13

The image forming element 8-3 and 8-8 were each imagewise exposed by scanning by a laser beam from a YAG laser (above-mentioned) and an image was formed in the same manner as in Example 6. The laser beam was focused at the interface between the layer containing the laser light absorbing substance and the transparent support, and the diameter of the condensed laser light L was varied. The sharpness of edge of the image formed on the support, the reproducibility of the diameter of condensed laser light L and the density D at the imagewise exposed portion were evaluated by the following procedure.

<Sharpness of Edge of the Image: ΔM>

The image forming element was exposed to a laser beam having a Gaussian energy distribution by scanning under conditions of a diameter of the condensed laser beam of L μm, a scanning pitch of L×2 μm and exposing energy of 200 mJ/cm². Thus obtained image was observed by a microscope to determined the maximum fluctuation width of the edge of the image ΔM.

<Reproducibility of the Condensed Diameter Width of Laser Light: N, ΔN>

The scanning exposure was performed by a laser beam having a Gaussian energy distribution under conditions of a diameter of condensed laser beam of L μm, a scanning pitch of L μm and exposing energy of 200 mJ/cm², so that a line image having a width of L×3 gm and a length of 100 mm. The width of the line image was measured by a microscope at optionally selected 100 points and the average of the width N and the difference between the largest value and the smallest value of the measured width of the line image ΔN were determined.

<Density at the Exposed Portion: D, ΔDₘᵢₙ>

The scanning exposure was performed by a laser beam having a Gaussian energy distribution under conditions of a diameter of condensed laser beam of L μm, a scanning pitch of L μm and exposing energy of 200 mJ/cm², so that an uniform image having a size of 10 cm×10 cm was formed. The transmission density of the image was measured by a densitometer in a visual density mode at optionally selected 100 points in the image to determine the average density D and the difference between the largest value and the smallest value among the measured values ΔDₘᵢₙ.

Thus obtained results are shown in Table 11.

TABLE 11

| | Image | | | | | | | |
|---|---|---|---|---|---|---|---|---|
| | forming | L | | | | | | |
| | element | (μm) | L/R | ΔM | N | ΔN | OD | ΔDₘᵢₙ |
| 13-1 | 8-8 | 4 | 11.11 | 0.22 | 8.41 | 0.44 | 0.049 | 0.019 |
| 13-2 | 8-8 | 5 | 13.89 | 0.25 | 10.23 | 0.52 | 0.018 | 0.018 |
| 13-3 | 8-8 | 7.5 | 20.83 | 0.29 | 15.13 | 0.59 | 0.010 | 0.015 |
| 13-4 | 8-8 | 10 | 27.78 | 0.37 | 20.05 | 0.78 | 0.008 | 0.013 |
| 13-5 | 8-3 | 12 | 81.08 | 0.28 | 24.08 | 0.57 | 0.029 | 0.015 |

### Example 14

The image forming element 10-2 and 10-5 were each imagewise exposed by scanning by a laser beam from the YAG laser DPY521-C-NP and an image was formed in the same manner as in Example 6. The laser beam was focused at the interface between the layer containing the laser light absorbing substance and the transparent support, and the diameter of the condensed laser light L was varied. The sharpness of edge of the image formed on the support, the reproducibility of the area of condensed laser light beam and the density Dn at the imagewise exposed portion were evaluated by the following procedure.

<Sharpness of Edge of the Image: ΔM>

The image forming element was scanned by a laser beam having a Gaussian energy distribution and a shape of rectangular with respect to the scanning direction under conditions of a diameter of the condensed laser beam of L gm, a condensed area of laser light beam S μm², a scanning pitch of L μm and exposing energy of 200 mJ/cm² to form a halftone image composed of 95% round dots of 175 line with an angle of 0°. Thus obtained image was observed by a microscope to determined the maximum fluctuation width of the edge of the image ΔM.

<Reproducibility of the Condensed Light Beam Area of Laser Light: T, ΔT>

The image forming element was scanned by a laser beam having a Gaussian energy distribution and a shape of rectangular with respect to the scanning direction under conditions of a diameter of the condensed laser beam of L μm, a condensed area of laser light beam S μm², a scanning pitch of L gm and exposing energy of 210 mJ/cm² to form a halftone image having a size of about 10 cm×100 cm and composed of 50% round dots of 175 line with an angle of 45°. The dot percentage T was measured by a densitometer at optionally selected 100 points, and the average dot percentage T and the difference between the largest value and the smallest value of the percentage ΔT were determined.

<Density at the Exposed Portion: D, ΔDₘᵢₙ>

The image forming element was scanned by a laser beam having a Gaussian energy distribution and a shape of -rectangular with respect to the scanning direction under conditions of a diameter of the condensed laser beam of L am, a condensed area of laser light beam S μm², a scanning pitch of L gm and exposing energy of 210 mJ/cm² to form a halftone image having a size of about 10 cm×10 cm and composed of 0% round dots of 175 line with an angle of 45°. The transmission density of the image was measured by a densitometer at a visual density mode at optionally selected 100 points in the image to determine the average density D and the difference between the largest density and the smallest density among the measured values ΔDₘᵢₙ.

Thus obtained results are shown in Table 12.

TABLE 12

| | Image | | | | | | | | |
|---|---|---|---|---|---|---|---|---|---|
| | forming | L | S | | | | | | |
| | element | (μm) | (μm²) | S/R | ΔM | T | ΔT | OD | ΔODₘᵢₙ |
| 14-1 | 10-5 | 4 | 8 | 33.76 | 0.15 | 48.3 | 0.03 | 0.036 | 0.019 |
| 14-2 | 10-5 | 5 | 16 | 67.51 | 0.16 | 49.1 | 0.03 | 0.033 | 0.013 |
| 14-3 | 10-5 | 7.5 | 32 | 135.02 | 0.17 | 49.6 | 0.05 | 0.021 | 0.009 |
| 14-4 | 10-5 | 10 | 60 | 253.16 | 0.17 | 50 | 0.06 | 0.011 | 0.004 |
| 14-5 | 10-2 | 10 | 60 | 639.59 | 0.09 | 50.8 | 0.04 | 0.075 | 0.014 |
| 14-6 | 10-2 | 15 | 100 | 1065.99 | 0.21 | 49.7 | 0.09 | 0.081 | 0.018 |
| 14-7 | 10-2 | 17 | 110 | 1172.59 | 0.29 | 49.3 | 0.11 | 0.089 | 0.018 |
| 14-8 | 10-2 | 17 | 115 | 1225.89 | 0.31 | 48.4 | 0.12 | 0.089 | 0.019 |

What is claimed is:

1. An ablation image forming method comprising the step of
imagewise irradiating a image forming element comprising an ablation image forming layer having a thickness of D by a laser light beam having a condensed area S at half maximum intensity so as to imagewise ablate the layer,
wherein the thickness of the image forming layer D and the condensed area S of the laser light beam satisfy the following relation;
12≦S/D≦145.

2. The ablation image forming method of claim 1, wherein said ablation image forming layer comprises two or more layers and at least one of the layers contains a laser light absorbing substance.

3. The ablation image forming method of claim 2, wherein the thickness d of said layer containing the laser light absorbing substance and the condensed area S of the laser light beam satisfy a relation of 15≦S/d≦17.

4. The ablation image forming method of claim 2, wherein said laser light absorbing substance is in a form of particle.

5. The ablation image forming method of claim 4, wherein the laser light absorbing substance is a mixture of two or more kinds of particles different from each other in the average diameter or the average major axis length thereof.

6. The ablation image forming method of claim 4. wherein said particle of the laser light absorbing substance is a ferromagnetic powder.

7. The ablation image forming method of claim 2, wherein said laser light absorbing substance is a dye.

8. The ablation image forming method of claim 2, wherein said image forming element comprises a transparent support and said layer containing the laser light absorbing substance is provided on one side of said transparent support.

9. The ablation image forming method of claim 8, wherein said image forming element comprises said transparent support having on one side thereof said layer containing the laser light absorbing substance and a layer containing no the laser light absorbing substance in this order from the support.

10. The ablation image forming method of claim 8, wherein said image forming element further has a peeling sheet on the side of the transparent support on which said layer containing the laser light absorbing substance is provided.

11. The ablation image forming method of claim 1, wherein the said image forming element comprises a transparent support and the irradiation by the laser light beam is given from the side of the transparent support.

12. The ablation image forming method of claim 11, wherein said image forming element further has peeling sheet having a transparent support, and the irradiation by the laser light beam is given from the side of transparent support of the image forming element, and the peeling sheet is peeled off after imagewise irradiation by the laser light beam.

13. The ablation image forming method of claim 11, wherein said layer to be ablated comprises the layer containing the laser light absorbing substance, and the area of the laser light beam S is defined at the interface of the transparent support and the layer containing the laser light absorbing substance.

14. The ablation image forming method of claim 1, wherein the imagewise irradiation was given by scanning the laser light beam.
